(19) United States
(12) Patent Application Publication
(10) Pub. No.: US 2021/0122557 A1
(43) Pub. Date: Apr. 29, 2021

(54) BOTTLE INSERT AND KIT

(71) Applicant: LOG Plastic Products (1993) Ltd, Kibbutz Ashdot Yaacov Ichud (IL)

(72) Inventors: Neta Moshe Cohen, GIVAT-ELAH (IL); Oded Golan, Kefar Tavor (IL); Ephraim Ulmer, Haifa (IL)

(73) Assignee: LOG Plastic Products (1993) Ltd, Kibbutz Ashdot Yaacov Ichud (IL)

(21) Appl. No.: 16/895,227

(22) Filed: Jun. 8, 2020

Related U.S. Application Data
(63) Continuation of application No. 15/667,659, filed on Aug. 3, 2017, now abandoned.
Application No. 15/667,659 is a continuation of application No. PCT/IL2016/050132, filed on Feb. 4, 2016.
(60) Provisional application No. 62/504,700, filed on May 11, 2017.
(60) Provisional application No. 62/112,187, filed on Feb. 5, 2015.

(51) Int. Cl. B65D 81/26; B65D 51/26; B65D 51/30; B65D 83/04

(52) U.S. Cl. CPC B65D 81/266; B65D 83/0481; B65D 51/30; B65D 51/26

(57) ABSTRACT

A bottle insert for absorbing gas or humidity of a bottle, the bottle insert includes a neck adapted to fit against the inside of a neck of the bottle; a first chamber adapted for storing a first substance; a second chamber adapted for storing a second substance; and a permeable partition adapted to be located between an interior of the bottle and at least one of the first chamber and the second chamber.

### CROSS REFERENCE

This application is a continuation of U.S. patent application Ser. No. 15/667,659 filing date Aug. 3, 2017 which is a continuation in part of PCT patent PCT/IL2016/050132 international filing date Feb. 4, 2016, which claims priority from U.S. provisional patent 62/112,187 filing date Feb. 5, 2015. This application also claims priority of U.S. provisional patent 62/504,700 filing Date May 11, 2017. All patents and patent applications are incorporated herein by their entirety.

### FIELD OF THE INVENTION

Embodiments of the invention relates to inserts for bottles. Specifically, the invention relates to inserts for reduction of the bottle volume, controlled release of bottle's content and for absorbing materials.

### BACKGROUND OF THE INVENTION

Bottles for carrying tablets are many times much larger than the volume required for the tablets. This may be due to labeling requirements, regulations or marketing considerations. For example, labeling of medicine bottles should include information as dictated by relevant regulation standards, and this information should be presented in a clear form with minimal font size. A reduction of the volume of the bottle may be required to prevent excessive tablet movement and breakage as well as for reducing headspace and thus reducing exposure to undesired conditions, such as humidity and oxidation.

In addition, extending the shelf life of the tablets often requires placing desiccants, oxygen scavengers or other absorbing materials inside the bottle. The absorbing materials should be easily distinguished from the tablets to avoid any possibility of confusion by the user.

### SUMMARY OF THE INVENTION

According to some embodiments of the present invention, there is provided a bottle insert and a kit that includes a bottle and a bottle insert.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic front view illustration of a first example of a bottle insert according to embodiments of the present invention;

FIG. 2 is a schematic bottom view illustration of the first example of a bottle insert according to embodiments of the present invention;

FIG. 3 is a schematic side view illustration of the first example of a bottle insert according to embodiments of the present invention;

FIG. 4 is a schematic rear view illustration of the first example of a bottle insert according to embodiments of the present invention;

FIG. 5 is a schematic top view illustration of the first example of a bottle insert according to embodiments of the present invention;

FIG. 6 is a schematic isometric view illustration of the first example of a bottle insert according to embodiments of the present invention;

FIG. 7 is a schematic front view illustration of a second example of a bottle insert according to embodiments of the present invention;

FIG. 8 is a schematic bottom view illustration of the second example of a bottle insert according to embodiments of the present invention;

FIG. 9 is a schematic side view illustration of the second example of a bottle insert according to embodiments of the present invention;

FIG. 10 is a schematic rear view illustration of the second example of a bottle insert according to embodiments of the present invention;

FIG. 11 is a schematic top view illustration of the second example of a bottle insert according to embodiments of the present invention;

FIG. 12 is a schematic isometric view illustration of the second example of a bottle insert according to embodiments of the present invention;

FIG. 13 is a schematic illustration of a cross-sectional view of the first insert assembled inside a bottle, with closed induction seal, according to embodiments of the present invention;

FIG. 14 is a schematic illustration of a cross-sectional view of the first insert assembled inside a bottle, with slightly opened induction seal, according to embodiments of the present invention;

FIG. 15 is a schematic illustration of a cross-sectional view of the second insert assembled inside a bottle, with closed induction seal, according to embodiments of the present invention;

FIG. 16 is a schematic illustration of a cross-sectional view of the second insert assembled inside a bottle, with slightly opened induction seal, according to embodiments of the present invention;

FIG. 17 is a schematic illustration of a cross-sectional view of a third insert assembled inside a bottle, with closed induction seal, according to embodiments of the present invention;

FIG. 18 is a schematic illustration of a cross-sectional view of the third insert assembled inside a bottle, with slightly opened induction seal, according to embodiments of the present invention;

FIG. 19 is an enlarged view of marked area K in the schematic cross-sectional view of the third insert assembled inside the bottle of FIG. 17, according to embodiments of the present invention;

FIG. 20 is a schematic illustration of a cross-sectional view of a fourth insert assembled inside a bottle, with closed induction seal, according to embodiments of the present invention;

FIG. 21 is a schematic illustration of a cross-sectional view of the fourth insert assembled inside a bottle, with slightly opened induction seal, according to embodiments of the present invention;

FIG. 22 is a schematic front view illustration of a fifth bottle insert, according to embodiments of the present invention;

FIG. 23 is a schematic top view illustration of the fifth example of a bottle insert, according to embodiments of the present invention;

FIG. 24 is a schematic bottom view illustration of the fifth example of a bottle insert, according to embodiments of the present invention;

FIG. 25 is a first schematic isometric view illustration of the fifth example of a bottle insert, according to embodiments of the present invention;

FIG. 26 is a second schematic isometric view illustration of the fifth example of a bottle insert, according to embodiments of the present invention;

FIG. 27 is a schematic illustration of a cross-sectional view of the fifth example of a bottle insert, according to embodiments of the present invention;

FIG. 28 is a schematic illustration of a cross-sectional view of the fifth insert assembled inside a bottle, according to embodiments of the present invention;

FIG. 29 is a schematic front view illustration of a fifth bottle insert, according to embodiments of the present invention;

FIG. 30 is a schematic top view illustration of the sixth example of a bottle insert, according to embodiments of the present invention;

FIG. 31 is a schematic bottom view illustration of the sixth example of a bottle insert, according to embodiments of the present invention;

FIG. 32 is a first schematic isometric view illustration of the sixth example of a bottle insert, according to embodiments of the present invention;

FIG. 33 is a second schematic isometric view illustration of the sixth example of a bottle insert, according to embodiments of the present invention;

FIG. 34 is a schematic illustration of a cross-sectional view of the sixth example of a bottle insert, according to embodiments of the present invention;

FIG. 35 is a schematic illustration of a cross-sectional view of the sixth insert assembled inside a bottle, according to embodiments of the present invention;

FIG. 36 is a schematic front view illustration of a seventh bottle insert, according to embodiments of the present invention;

FIG. 37 is a schematic top view illustration of the two stage example of a bottle insert, according to embodiments of the present invention;

FIG. 38 is a schematic bottom view illustration of the seventh example of a bottle insert, according to embodiments of the present invention;

FIG. 39 is a first schematic isometric view illustration of the seventh example of a bottle insert, according to embodiments of the present invention;

FIG. 40 is a second schematic isometric view illustration of the seventh example of a bottle insert, according to embodiments of the present invention;

FIG. 41 is a schematic illustration of a cross-sectional view of the seventh example of a bottle insert, according to embodiments of the present invention;

FIG. 42 is a schematic front view illustration of a two stage bottle insert, according to embodiments of the present invention;

FIG. 43 is a schematic top view illustration of the two stage example of a bottle insert, according to embodiments of the present invention;

FIG. 44 is a schematic bottom view illustration of the two stage example of a bottle insert, according to embodiments of the present invention;

FIG. 45 is a schematic isometric view illustration of the two stage example of a bottle insert, according to embodiments of the present invention;

FIG. 46 is a first schematic illustration of a cross-sectional view of the two stage example of a bottle insert, according to embodiments of the present invention;

FIG. 47 is second schematic illustration of a cross-sectional view of the two stage example of a bottle insert, according to embodiments of the present invention;

FIG. 48 is an exploded view of parts of the two stage example of a bottle insert, according to embodiments of the present invention

FIG. 49 is a schematic illustration of a first cross-sectional view of the two stage insert assembled inside a bottle, according to embodiments of the present invention;

FIG. 50 is a schematic illustration of a second cross-sectional view of the two stage insert assembled inside a bottle, according to embodiments of the present invention;

FIG. 51 is an exploded view of parts of an example of a two stage bottle insert assembled in a bottle, according to embodiments of the present invention;

FIG. 52 is a schematic front view illustration of a second two stage bottle insert, according to embodiments of the present invention;

FIG. 53 is a schematic top view illustration of the second two stage example of a bottle insert, according to embodiments of the present invention;

FIG. 54 is a schematic bottom view illustration of the second two stage example of a bottle insert, according to embodiments of the present invention;

FIG. 55 is a schematic isometric view illustration of the second two stage example of a bottle insert, according to embodiments of the present invention;

FIG. 56 is a schematic a cross-sectional isometric view of the second two stage example of a bottle insert, according to embodiments of the present invention;

FIG. 57 is a schematic isometric view illustration of the second two stage example of a bottle insert assembled inside a bottle, according to embodiments of the present invention;

FIG. 58 is a schematic cross-sectional isometric view of the second two stage example of a bottle insert assembled inside a bottle, according to embodiments of the present invention;

FIG. 59 is a schematic isometric view illustration of the second two stage example of a bottle insert assembled inside a bottle, according to embodiments of the present invention;

FIG. 60 is a schematic cross-sectional isometric view of the second two stage example of a bottle insert assembled inside a bottle, according to embodiments of the present invention;

FIG. 61 is a schematic isometric view illustration of an example of a bottle insert assembled inside a bottle, according to embodiments of the present invention;

FIG. 62 is a schematic cross-sectional isometric view of an example of a bottle insert assembled inside a bottle, according to embodiments of the present invention;

FIG. 63 is a schematic isometric view illustration of an example of a bottle insert assembled inside a bottle, according to embodiments of the present invention;

FIG. 64 is a schematic cross-sectional isometric view of an example of a bottle insert assembled inside a bottle, according to embodiments of the present invention;

FIG. 65 is a schematic cross-sectional isometric view of an example of a bottle insert assembled inside a bottle, according to embodiments of the present invention;

FIG. 66 is a schematic cross-sectional isometric view of an example of a bottle insert assembled inside a bottle, according to embodiments of the present invention;

FIG. 67 is a schematic cross-sectional view of an example of a bottle insert, according to embodiments of the present invention;

FIG. 68 is a schematic cross-sectional isometric view of an example of a bottle insert assembled inside a bottle, according to embodiments of the present invention;

FIG. 69 is a schematic cross-sectional isometric view of an example of a bottle insert assembled inside a bottle, according to embodiments of the present invention;

FIG. 70 is an isometric view of an example of a bottle insert, according to embodiments of the present invention;

FIG. 71 is a schematic cross-sectional isometric view of an example of a bottle insert assembled inside a bottle, according to embodiments of the present invention;

FIG. 72 is a schematic cross-sectional view of an example of a bottle insert assembled inside a bottle, according to embodiments of the present invention;

FIG. 73 is a schematic cross-sectional view of an example of a bottle insert assembled inside a bottle, according to embodiments of the present invention;

FIG. 74 is an example of cross sectional view of a bottle insert that is inserted into a bottle;

FIGS. 75 and 76 illustrate two phases of an insertion process;

FIGS. 77 and 78 illustrate two phases of an insertion process of a body insert; and

FIGS. 79A and 79B are examples of a cross sectional view of a bottle insert, and a radius of an upper part and a lower part of a neck of a bottle after the insertion of the bottle insert;

FIG. 80 is an example of a bottle insert and a bottle;

FIG. 81 is an example of a bottle insert and a bottle;

FIG. 82 is an example of a bottle insert;

FIG. 83 is an example of a bottle insert;

FIG. 84 is an example of a bottle insert;

FIG. 85 is an example of a bottle insert and a bottle;

FIG. 86 is an example of a neck of a bottle;

FIG. 87 is an example of a bottle insert and a bottle;

FIG. 88 is an example of a bottle insert and a bottle;

FIG. 89 is an example of a bottle insert and a bottle;

FIG. 90 is an example of a bottle insert and a bottle;

FIG. 91 is an example of a method;

FIG. 92 is an example of a bottle insert and a bottle;

FIG. 93 is an example of a bottle insert and a bottle;

FIG. 94 is an example of a bottle insert and a bottle;

FIG. 95 is an example of a threads and one or more spaced apart protuberances; and

FIGS. 96, 97, 98 and 99 illustrate two phases of an insertion process.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Although embodiments of the present invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Any reference to a prevention of movement should be read as a prevention of a substantial movement. A substantial movement upwards may cause the bottle insert to be extracted from the bottle. A substantial movement downwards may cause the bottle insert to escape the neck of the bottle and be position in another region of the bottle. A substantial movement may be a movement of magnitude that exceeds a certain fraction (for example between 5-90%, especially between 30-60%) of the length of the bottle insert. A substantial movement may be a movement of magnitude that exceeds a certain fraction (for example between 5-90%, especially between 30-60%) of the length of the beck of the bottle.

Embodiments of the present invention may relate to a bottle insert or desiccant stent for reducing the volume of a bottle. Throughout the application the terms bottle insert, desiccant stent, an insert or a stent may be used interchangeably and have the same meaning. The insert may include a neck and a body. The neck may be configured to fit tightly against the inside of the neck of the respective bottle. The rim of the neck of the insert may be below (e.g., slightly below) or substantially aligned with the rim of the neck of the bottle, to allow fitting of an induction seal. The body of the insert may have a volume and may be placed inside the bottle to reduce the free volume or unfilled space, also referred to as headspace, of the bottle by the volume of the body.

Embodiments of the present invention may further relate to a bottle insert or desiccant stent with a chamber or a plurality of chambers for storing a substance. The one or more chambers may be adapted to store any desired material or substance, e.g., an absorbing material, for example, at least one or a combination of: desiccants, oxygen scavengers or absorbers, or any desired substance for adsorbing unwanted gases and organic molecules. While the chambers disclosed herein are described as usable for storing absorbing materials, this feature is not-limiting and the chambers disclosed herein may be used for storing other materials or substances, as required by the application. According to embodiments of the present invention, connecting the absorbing materials to the bottle through the insert may prevent any possibility of confusion by the user, thus preventing consumption of the absorbing material. Other modules may be attached or loaded onto the insert, e.g., an Radio Frequency Identification (RFID) tag or near field communication (NFC) tag.

Embodiments of the present invention may further relate to a two stage bottle insert or a two stage bottle stent for storing substances. According to embodiments of the present invention the two stage bottle insert may include at least two chambers, where at least one chamber stores a substance usable or active during the shelf life of a product and at least a second chamber stores a substance usable or active after opening the bottle, when the bottle is in use. The absorbing material may be kept sealed until the bottle is opened for consumption to extend in-use life of the stored product.

According to embodiments of the present invention, chambers of the inserts or two stage bottle inserts may be separated from the interior or inner volume of the bottle by either impermeable material or permeable material, as disclosed herein. Using a permeable partition, separation or membrane may enable storing the substance in the confined chamber, while enabling the substance to be active and absorb undesired gases and humidity that may pass through the permeable partition. The permeable partition separation or membrane may be made of any suitable substance allowing gases and humidity to pass through, including but not limited to, paperboard or cardboard, various types of plastics or polymers, etc.

According to embodiments of the present invention, the bottle may be filled or adapted to be filled with pills, tablets or powders. For example, the bottle may be a medicine bottle for keeping pills. Other examples may include a bottle for tablets of food supplements, candies, sugar substitutes, etc. Embodiments of the present invention may be adapted to fit to practically any bottle, in any desired volume. Fitting the insert into the bottle may be done by any applicable method including, but not limited to, press fit, ultrasonic soldering and gluing.

According to embodiments of the present invention, the insert may include a slide and an opening configured to allow controlled disposing of tablets, e.g., dispensing of one tablet at a time. Some embodiments of the present invention may include an opening with no slide, or with a tunnel to guide tablets towards the opening of the bottle. While in some of the embodiments presented hereinbelow the opening may be depicted as round and concentric with the opening of the bottle, this is not mandatory, and the opening may have any desirable shape and may not necessarily be concentric with the opening of the bottle.

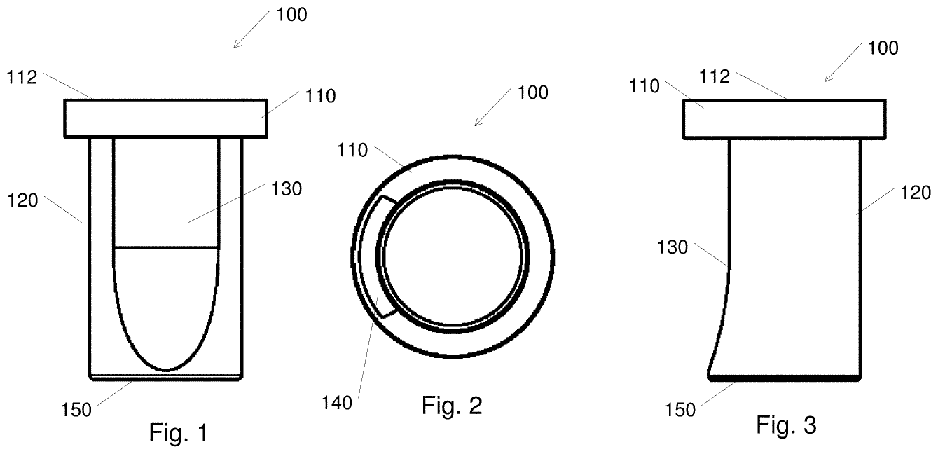

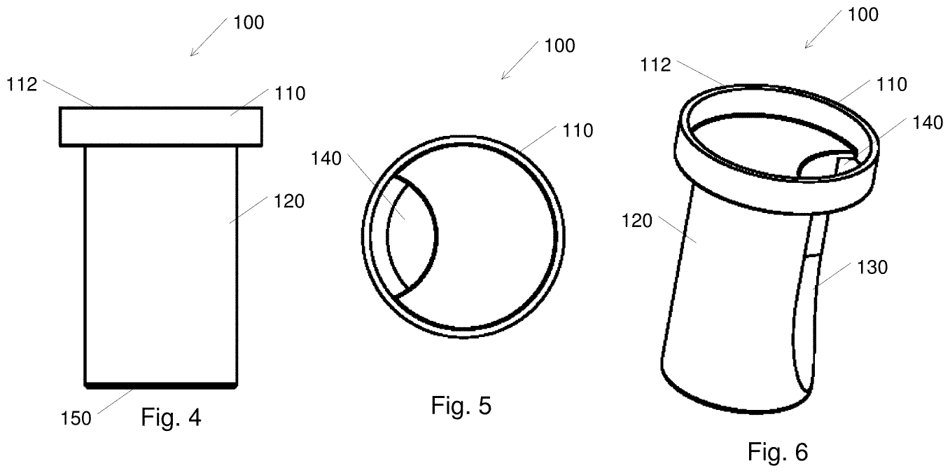

Reference is now made to FIGS. 1-6 which are schematic illustrations from a front view, a bottom view, a side view, a rear view, a top view and an isometric view, respectively, of a first example of a bottle insert 100 according to embodiments of the present invention. It should be noted that a second side view of insert 100 is identical to the side view depicted in FIG. 3.

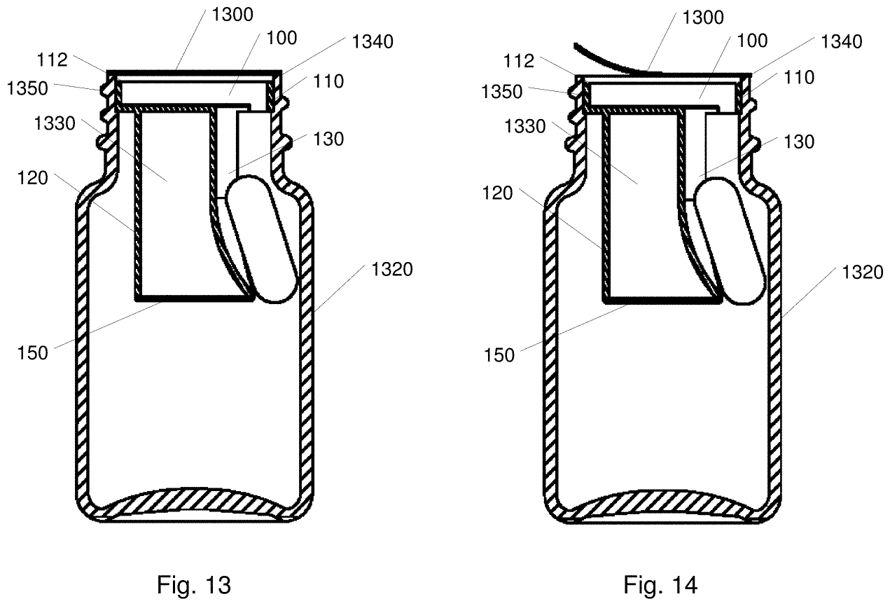

Insert 100 may include a neck 110 and a body 120. Neck 110 may be configured to fit against the inside of a neck of a bottle (e.g., bottle 1320 shown in FIGS. 13-16). It should be readily understood that while neck 110 is depicted as round, neck 110 may have other shapes that may fit the inside of the neck of the bottle. Rim 112 of neck 110 of the insert 100 may be below or substantially aligned with a rim of a neck of the bottle (e.g., rim 1340 of neck 1350 of bottle 1320 shown in FIGS. 13-19), to provide a sealing surface for an induction seal. The sealing surface may allow fitting of an induction seal over the bottle, to hermetically seal the bottle (e.g., induction seal 1300 in FIGS. 13-19). Rim 112 may refer to the top surface of neck 110, adapted to be fitted near or at the opening of the bottle.

Body 120 of insert 100 may have a volume and may be placed inside the bottle to reduce the free volume of the bottle by the volume of body 120. Reducing the free volume of the bottle by the volume of body 120 may allow a large surface area for the exterior of the bottle while keeping the interior volume of the bottle relatively small. The relatively large surface area of the exterior of the bottle may be used for placing a large label, which may enable using a desired font size and/or insertion of large amount of data. Keeping the interior volume of the bottle relatively small may prevent excessive tablet movement and breakage as well as reducing the headspace of the bottle and thus reducing exposure to undesired conditions, such as humidity and oxidation.

In the embodiment depicted in FIGS. 1-6 a bottom 150 of body 120 distant from neck 110 of insert 100 is substantially flat, however, this feature is non-limiting and bottom 150 may have any desired form, e.g., bottom 150 may be wavy, concave or convex, etc. According to some embodiments, bottom 150 may have a circular perimeter to allow easy closure of bottom 150, for example, with a circular permeable closing element, to allow gases and humidity to flow there through.

According to embodiments of the present invention, insert 100 may include a slide 130 and an opening 140 configured to allow controlled dispensing of tablets, e.g., one tablet at a time. The combination of the volume reduction body 110 with slide 130 and opening 140 is advantageous over existing volume reduction inserts since it enables controlled disposing of tablets without having to remove insert 100.

Body 120 of insert 100 may be hollow to reduce material and weight of insert 100. The hollow space of body 120 may be used as a chamber 1330 (FIGS. 13-14) for holding or storing any desired substance that needs to be placed inside bottle 100. Thus, desiccants and oxygen scavengers may be placed inside the bottle, but may be held by insert 100 and kept separated from the tablets. The chamber may include or may have porous exterior or a permeable partition to allow gasses and humidity flow there though, and ease of assembly. It is desirable to attach absorbing materials such as desiccants and oxygen scavengers to the bottle, in order to prevent the user from confusing between them and the tablets. However, attaching desiccants and oxygen scavengers directly to the bottle may be complex relatively to attaching desiccants and oxygen scavengers to insert 100, or placing them in a chamber of insert 100 since the access to the inside of the bottle may be less convenient than the access to insert 100 (before insert 100 is placed inside the bottle). Other modules may be attached or loaded onto insert 100, e.g., an RFID and/or an NFC tag.

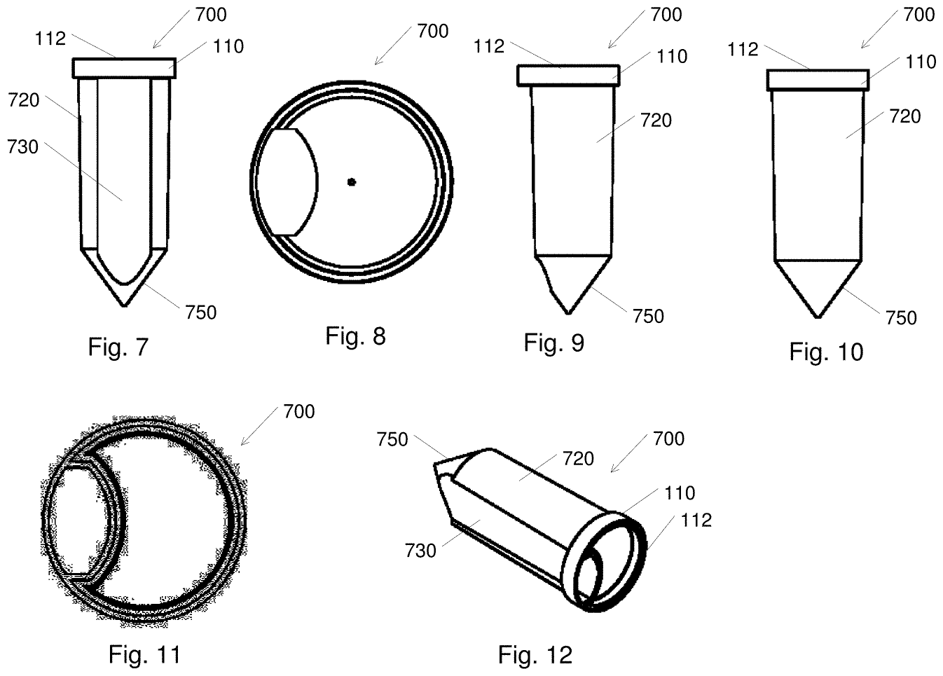

Reference is now made to FIGS. 7-12 which are schematic illustrations from a front view, a bottom view, a side view, a rear view, a top view illustration, and a schematic isometric view, respectively, of a second bottle insert 700 according to embodiments of the present invention. It should be noted that a second side view of insert 700 is identical to the side view depicted in FIG. 9. Second bottle insert 700 may be substantially similar to bottle insert 100. Elements of insert 700 that are similar to insert 100 may be given the same reference numerals and may not be described again. Bottom 750 of insert 700 may be substantially conic. Substantially conic bottom 750 may enable easy insertion of insert 700 into the bottle, even when the bottle is already filled with tablets. Second bottle insert 700 may include slide 730 and body 720 that are similar to slide 130 and body 120.

Reference is now made to FIGS. 13-14 which are schematic illustrations of a cross-sectional view of insert 100 assembled inside bottle 1320, according to embodiments of the present invention. Insert 100 may be assembled inside bottle 1320 so that rim 112 of neck 110 of insert 100 is below or substantially aligned with a rim 1340 of neck 1350 of bottle 1320. Rim 1340 may refer to the outer surface of neck 1350. In FIGS. 13-14 an induction seal 1300 is fitted to the sealing surface provided by rim 1340 of neck 1350 of bottle 1320. Induction seal 1300 is closed in FIG. 13 and slightly opened in FIG. 14. Also visible in FIGS. 13-14 is chamber 1330 located in the hollow space inside body 120.

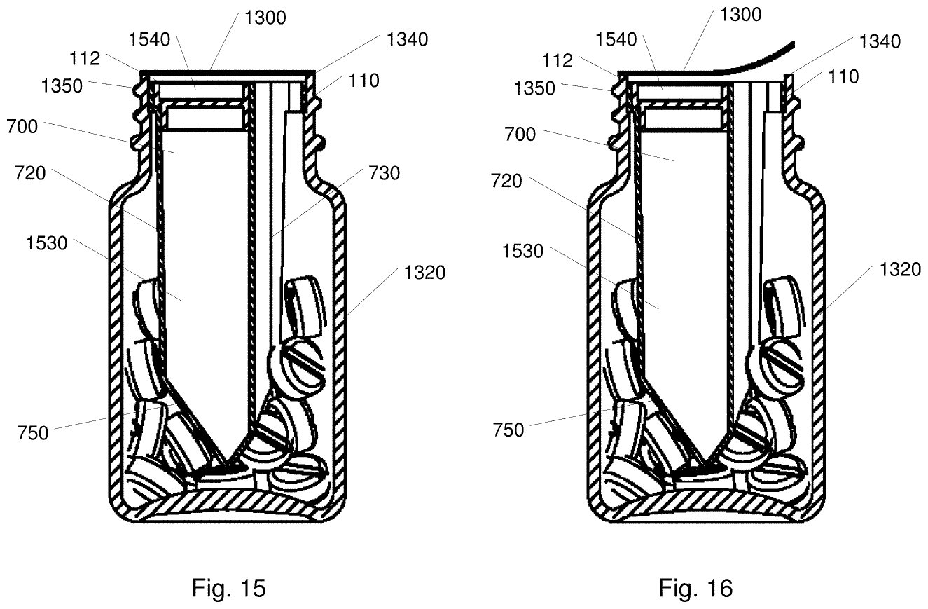

Reference is now made to FIGS. 15-16 which are schematic illustrations of a cross-sectional view of insert 700 assembled inside bottle 1320 with tablets, according to embodiments of the present invention. Insert 700 may be assembled inside bottle 1320 similarly to insert 100. Also visible in FIGS. 15-16 is chamber 1530 located in the hollow space inside body 720 and RFID and/or NFC tag 1540.

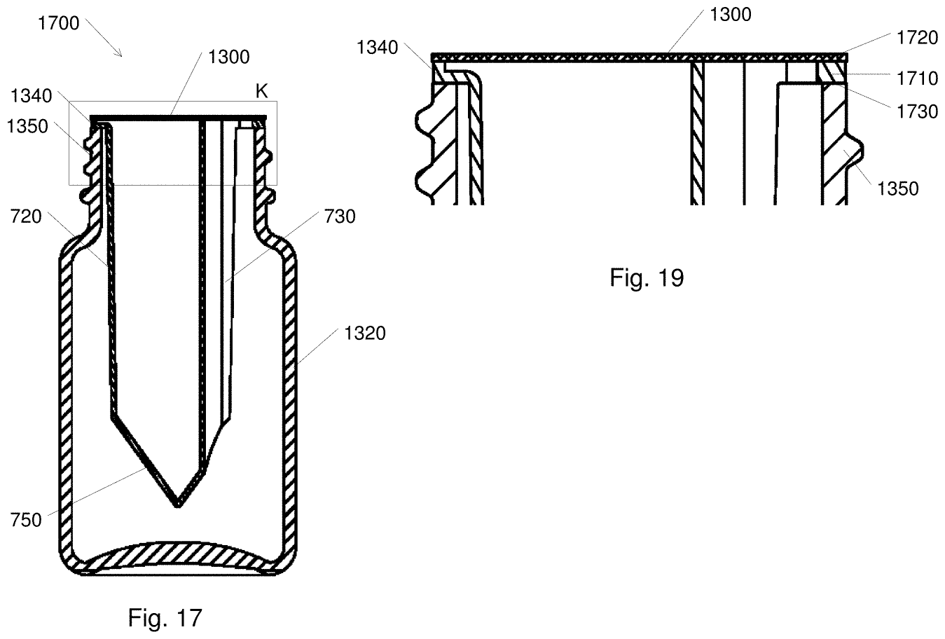

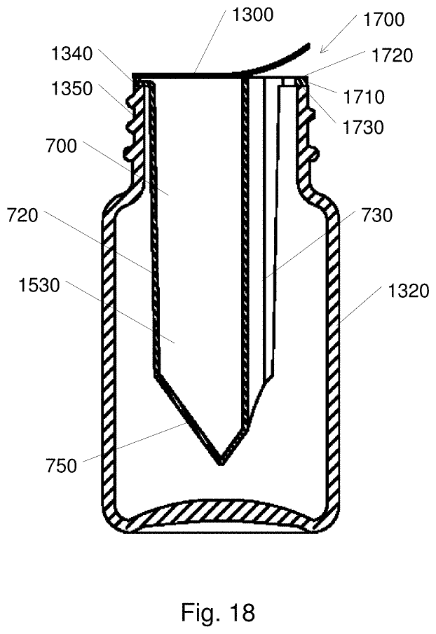

Reference is now made to FIGS. 17, 18 which are schematic illustrations of a cross-sectional view of insert 1700 assembled inside bottle 1320, and to FIG. 19 which is an enlarged view of marked area K, according to embodiments of the present invention. Insert 1700 may be assembled inside bottle 1320 so that bottom surface 1730 of neck 1710 of insert 1700 may abut rim 1340 of neck 1350 of bottle 1320. According to some embodiments appropriate sealing may be needed between bottom surface 1730 of neck 1710 and rim 1340 of neck 1350. Top surface 1720 of neck 1710 of insert 1700 may provide a sealing surface for induction seal 1300. In FIGS. 17-18 an induction seal 1300 is fitted to the sealing surface provided by top surface 1720 of neck 1710. Induction seal 1300 is closed in FIG. 17 and slightly opened in FIG. 18. Insert 1700 may be similar to insert 700 in other aspects. For example, bottom 750 of insert 1700 may be substantially conic.

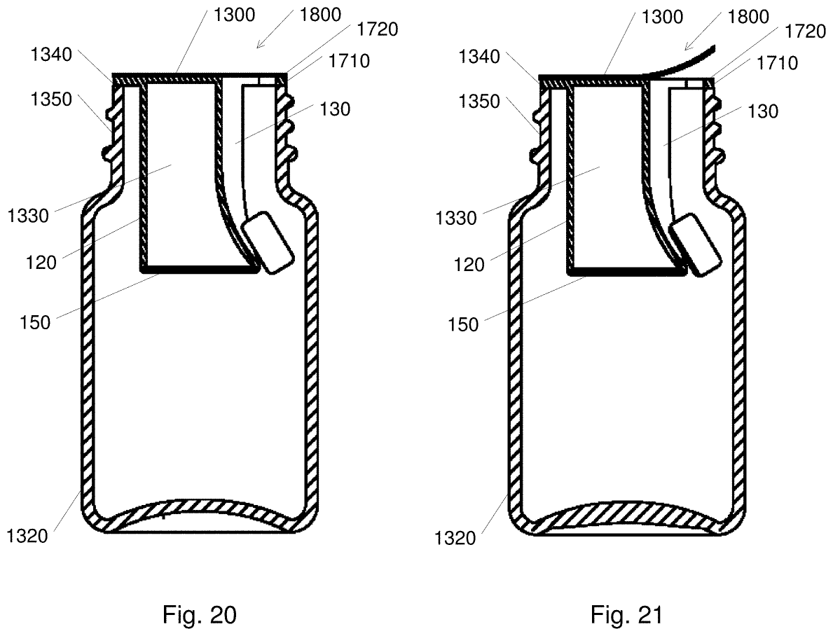

Reference is now made to FIGS. 20-21 which are schematic illustrations of a cross-sectional view of insert 1800 assembled inside bottle 1320, according to embodiments of the present invention. Similarly to insert 1700, insert 1800 may be assembled inside bottle 1320 so that neck 1710 of insert 1800 may abut rim 1340 of neck 1350 of bottle 1320. A top surface 1720 of neck 1710 of insert 1800 may provide a sealing surface for induction seal 1300. Induction seal 1300 is closed in FIG. 20 and slightly opened in FIG. 21. Insert 1800 may be similar to insert 100 in other aspects. For example, bottom 150 of insert 1800 may be substantially flat, or have any desired form, e.g., bottom 150 may be wavy, concave or convex, etc.

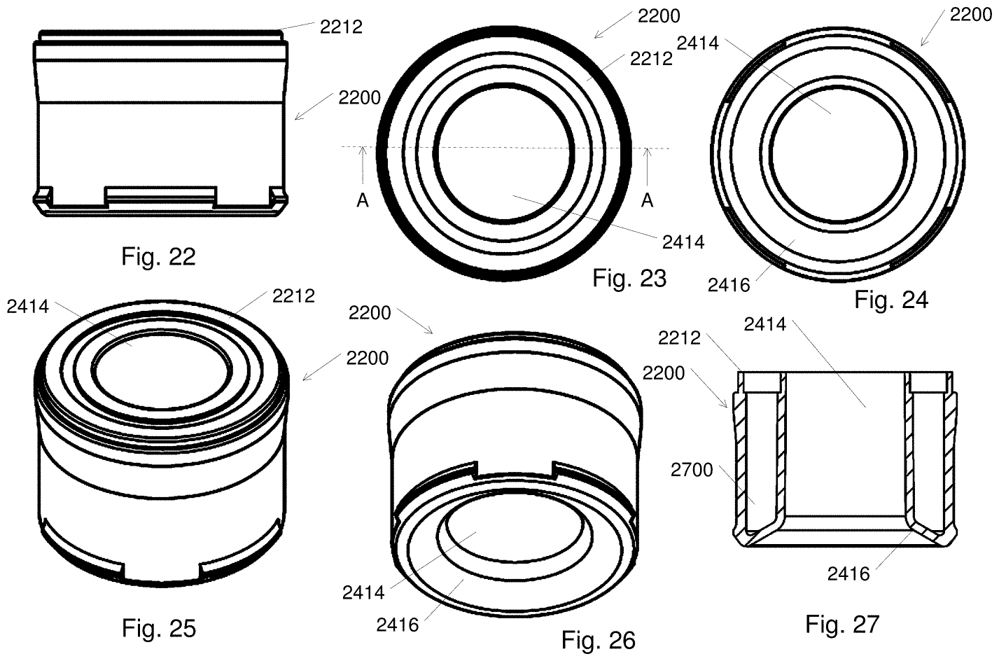

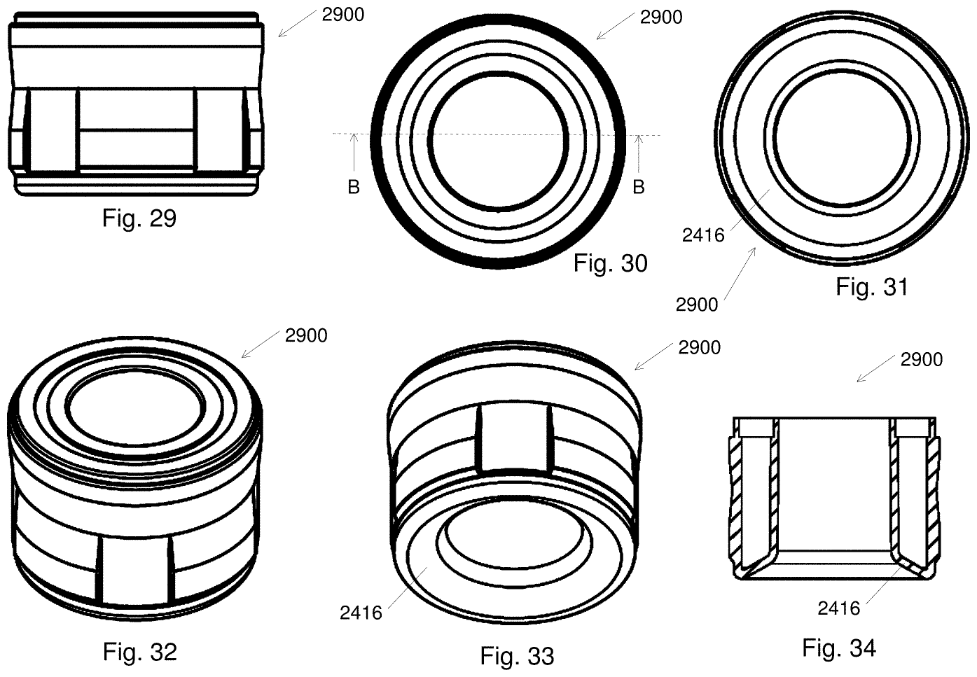

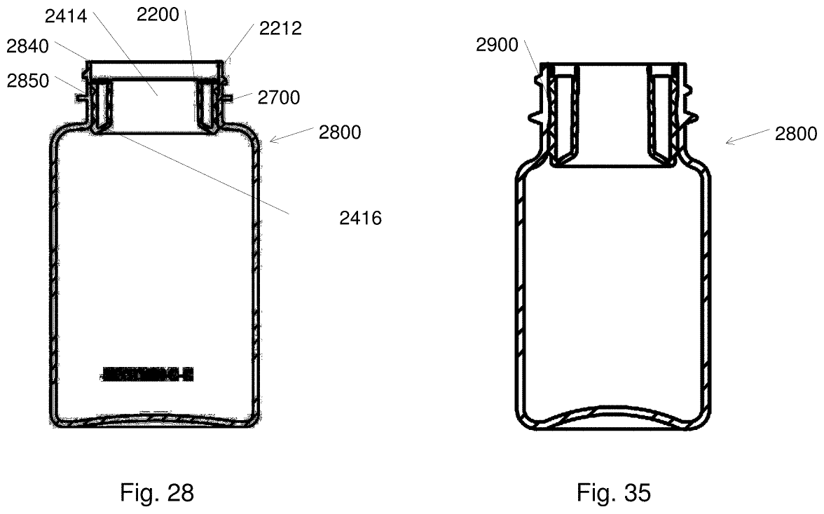

Reference is now made to FIGS. 22-27 which are schematic illustrations from a front view, a top view, a bottom view, two isometric views, and a cross-sectional view along section line AA, respectively, of a fifth bottle insert 2200 according to embodiments of the present invention. It should be noted that the rear view and the two side views of insert 2200 are identical to the front view depicted in FIG. 22. Reference is also made to FIG. 28 which is a schematic illustration of a cross-sectional view of insert 2200 assembled inside bottle 2800, according to embodiments of the present invention.

Insert 2200 may include a neck configured to fit against the inside of a neck of a bottle, e.g., bottle 2800. It should be readily understood that while insert 2200 is depicted as round, insert 2200 may have other shapes that may fit the inside of the neck a selected bottle. When placed into a bottle, rim 2212 of insert 2200 may be below or substantially aligned with a rim of a neck of the bottle, e.g., rim 2840 of neck 2850 of bottle 2800, to provide a sealing surface for an induction seal. The sealing surface may allow fitting of an induction seal (e.g., similar to induction seal 1300 in FIGS. 13-19). Rim 2212 may refer to the top surface of insert 2200. Insert 2200 may include an opening 2414 configured to allow dispensing of tablets. In some embodiments, insert 2200 may include a funnel 2416 to guide tablets towards the opening of bottle 2800. In some embodiments, opening 2414 may be configured to allow controlled dispensing of tablets.

Insert 2200 may include at least one chamber 2700 for storing a substance. Thus, the substance may be placed inside bottle 2800, but may be held by insert 2200 and kept separated from the tablets. Chamber 2700 may include or may have permeable or porous partition 2710 adapted to be located between the interior of the bottle and the chamber to allow humidity, oxygen and other gases pass through. Other modules may be attached or loaded onto insert 2200, e.g., an RFID/NFC tag.

Reference is now made to FIGS. 29-34 which are schematic illustrations from a front view, a top view, a bottom view, two isometric views, and a cross-sectional view along section line BB, respectively, of a sixth bottle insert 2900 according to embodiments of the present invention. It should be noted that the rear view and the two side views of insert 2900 are identical to the front view depicted in FIG. 29. Reference is also made to FIG. 35 which is a schematic illustration of a cross-sectional view of insert 2900 assembled inside bottle 2800, according to embodiments of the present invention. Insert 2900 have a similar functionality as insert 2200.

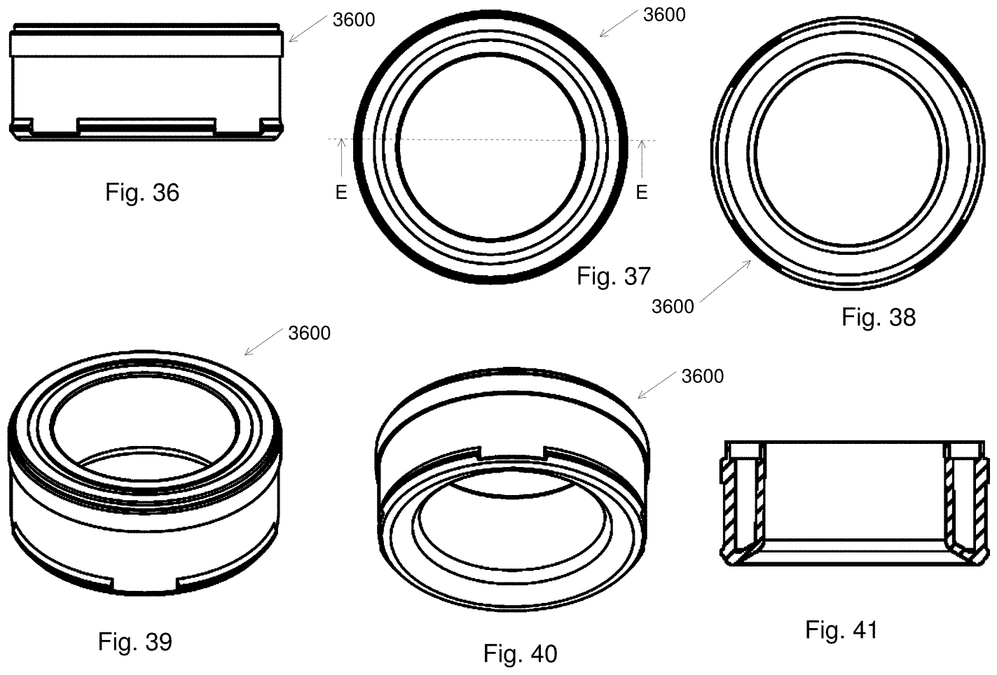

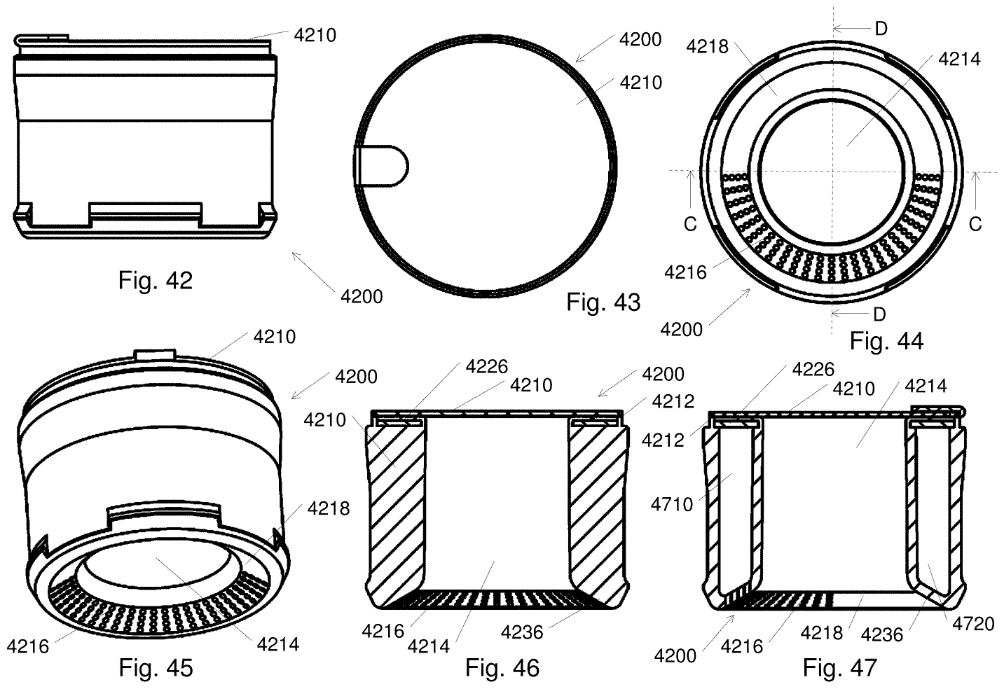

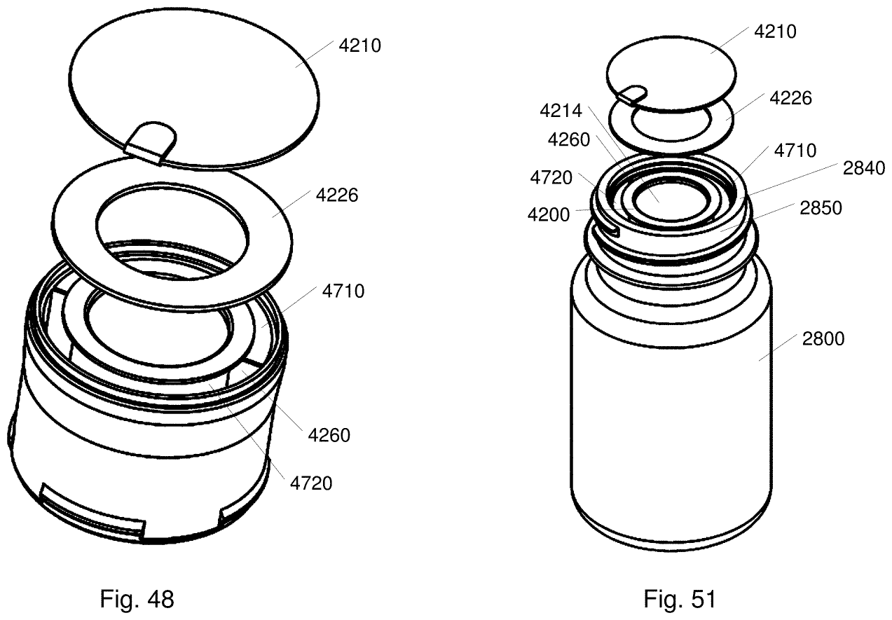

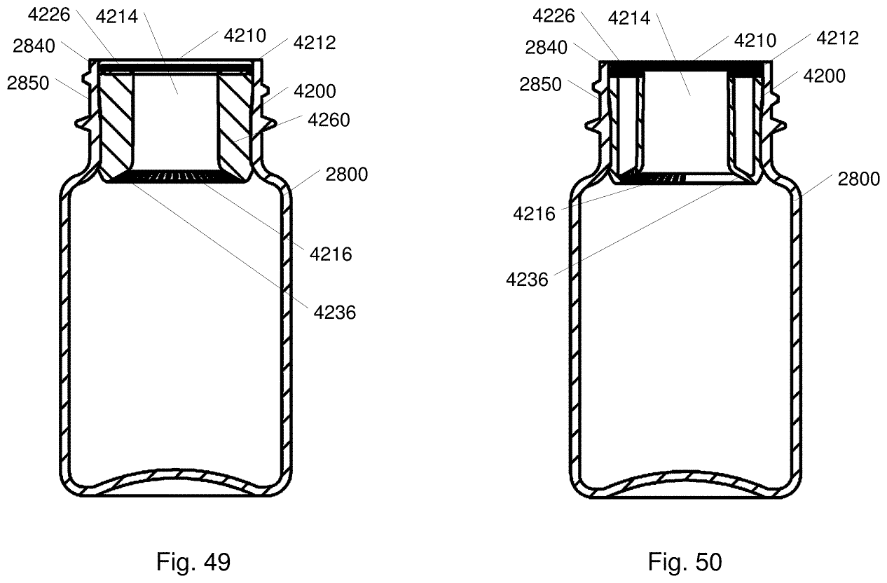

Reference is now made to FIGS. 36-41 which are schematic illustrations from a front view, a top view, a bottom view, two isometric views, and a cross-sectional view along section line EE, respectively, of a seventh bottle insert 3600 according to embodiments of the present invention. It should be noted that the rear view and the two side views of insert 3600 are identical to the front view depicted in FIG. 36. Insert 3600 have a similar functionality as insert 2200. 0 Reference is now made to FIGS. 42-47 which are schematic illustrations from a front view, a top view, a bottom view, an isometric view, a cross-sectional view along section line CC, and a cross-sectional view along section line DD, respectively, of a two stage bottle insert 4200 according to embodiments of the present invention. It should be noted that the rear view and the two side views of insert 4200 are identical to the front view depicted in FIG. 42. Reference is also made to FIG. 48 which is an exploded view of parts of insert 4200 (including permeable top seal 4226) and induction seal 4210, to FIGS. 49 and 50 which are schematic illustration of a cross-sectional views of insert 4200 assembled inside bottle 2800, and to FIG. 51 which is an exploded view of parts of an example of a two stage bottle insert assembled in a bottle according to embodiments of the present invention.

Insert 4200 may include a neck configured to fit against the inside of neck of a bottle, e.g., neck 2850 of bottle 2800. It should be readily understood that while insert 4200 is depicted as round, insert 8200 may have other shapes that may fit the inside of the neck a selected bottle. When placed into a bottle, rim 4212 of insert 4200 may be below or substantially aligned with a rim of a neck of the bottle, e.g., rim 2840 of neck 2850 of bottle 2800, to provide a sealing surface for an induction seal for bottle 2800 bottle (e.g., similar to induction seal 1300 shown in FIGS. 13-19 and 20-21). Rim 4212 may refer to the top surface of insert 4200. Insert 4200 may include an opening 4214 configured to allow dispensing of tablets. In some embodiments, insert 4200 may include a funnel 4236 to guide tablets towards the opening of bottle 2800. In some embodiments, opening 4214 configured to allow controlled dispensing of tablets.

Insert 4200 may include two stage chamber system including a plurality of chambers, including at least one shelf-life chamber 4710 and at least one in-use chamber 4720. The chambers may be separated by impermeable partitions 4260. While in the embodiment depicted in FIGS. 42-51 the partition is vertical, e.g., parallel to the plane of section CC, this is not-limiting. In some embodiments impermeable partitions 4260 may be horizontal e.g., perpendicular to the planes of sections CC and DD. As used herein, the terms vertical and horizontal may refer to their ordinary meaning with reference to bottle 2800 (with any of the inserts disclosed herein, e.g., as shown in FIGS. 28, 35 and 51), placed according to its ordinary use on its bottom surface.

A substance may be placed inside bottle 2800, but may be stored by insert 4200 and kept separated from the tablets. Shelf-life chamber 4710 may include or may have permeable or porous partition 4216 adapted to be located between the interior of bottle 2800 and shelf-life chamber 4710, to allow humidity, oxygen and other gases pass through from the interior of bottle 2800 to shelf-life chamber 4710. Thus, shelf-life chamber 4710 may be adapted for storing substances that may be usable or active regardless of whether bottle 2800 is sealed or not. The substances placed inside shelf-life chamber 4710 may be active throughout the entire life span of the bottle. However, it is expected that with time, the substances in shelf-life chamber 4710 may become saturated and less active.

In-use chamber 4720 may also store substances, similar or different than those stored in shelf-life chamber 4710. In-use chamber 4720 may include or may have an impermeable exterior 4218 facing the interior of bottle 2800, to block or not allow humidity, oxygen and other gases pass through from the interior of bottle 2800 to in-use chamber 4720. However, in-use chamber 4720 may have permeable or porous partition 4226. In some embodiments partition 4226 may be located at a top surface of insert 4200. Permeable or porous partition 4226 may be adapted to be kept sealed by, for example, induction seal 4210.

Induction seal 4210 may be placed on in-use chamber 4720 after filling in-use chamber 4720 with the required substances and possibly after filling bottle 2800 with tablets (or with any other items as required). Thus, in-use chamber 4720 may be kept sealed, and the substance inside in-use chamber 4720 may be kept fresh and active as long as induction seal 4210 is not removed.

After induction seal 4210 is removed, permeable or porous partition 4226 may face the interior of bottle 2800, to allow humidity, oxygen and other gases pass through from the interior of bottle 2800 to in-use chamber 4720. Thus, in-use chamber 4720 may be adapted for storing substances that may be usable or active when bottle 2800 is opened for use, e.g., when induction seal 4210 is removed.

According to some embodiments, a single induction seal, e.g., induction seal 4210, may be used to seal both in-use chamber 4720 and bottle 2800. According to some embodiments, a first induction seal, e.g., induction seal 4210, may be used to seal in-use chamber 4720 and a second induction seal, e.g., induction seal 1300, may be used to seal bottle 2800. Other modules may be attached or loaded onto insert 4200, e.g., an RHD/NFC tag.

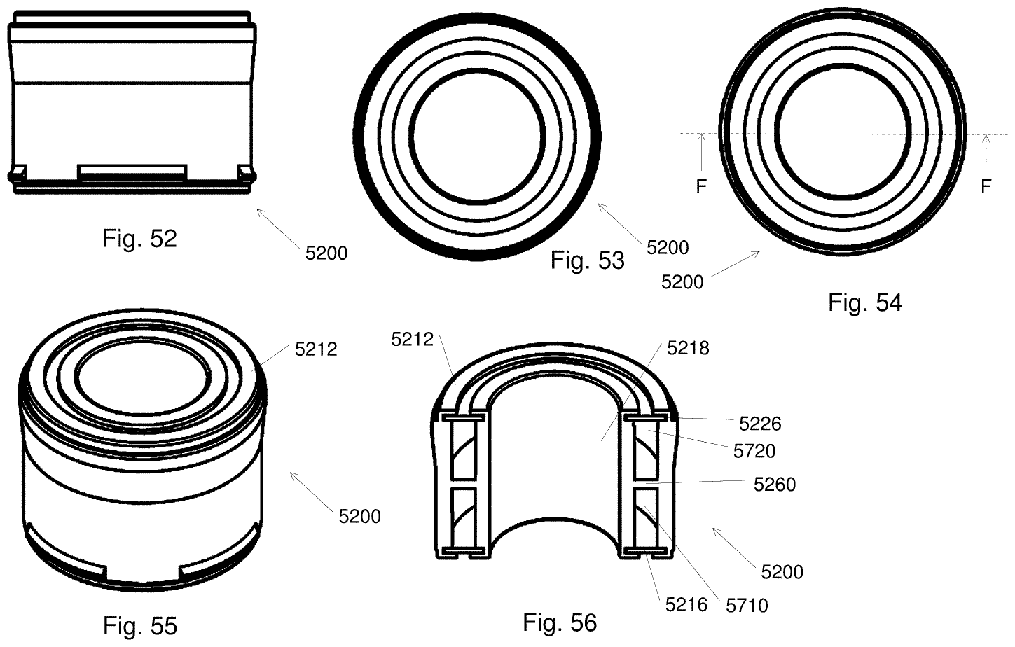

Reference is now made to FIGS. 52-56 which are schematic illustrations from a front view, a top view, a bottom view, an isometric view and a cross-sectional isometric view along section line FF, respectively, of a second two stage bottle insert 5200 according to embodiments of the present invention. It should be noted that the rear view and the two side views of insert 5200 are identical to the front view depicted in FIG. 52. Two stage bottle insert 5200 may be generally similar to two stage bottle insert 4200, and similar components may not be described again. The main difference between insert 5200 and insert 4200 is the design of the partition between the shelf-life chamber and the in-use chamber. While partition 4260 is vertical, partition 5260 is horizontal. Partition 5260 separates in-use chamber 5720 from shelf-life chamber 5710. It should be readily understood that each of chambers 5710 and 5720 may be further partitioned to a plurality of chambers.

Shelf-life chamber 5710 may include or may have permeable or porous partition 5216 adapted to be located between the interior of bottle 2800 and shelf-life chamber 5710, to allow humidity, oxygen and other gases pass through from the interior of bottle 2800 to shelf-life chamber 5710. Thus, shelf-life chamber 5710 may be adapted for storing substances that may be usable or active regardless of whether bottle 2800 is sealed or not. The substances placed inside shelf-life chamber 5710 may be active throughout the entire life span of the bottle. However, it is expected that with time, the substances in shelf-life chamber 5710 may become saturated and less active.

In-use chamber 5720 may also store substances, similar or different than those stored in shelf-life chamber 5710. In-use chamber 5720 may include or may have an impermeable exterior 5218 facing the interior of bottle 2800, to block or not allow humidity, oxygen and other gases pass through from the interior of bottle 2800 to in-use chamber 5720. However, in-use chamber 5720 may have permeable or porous partition 5226. In some embodiments partition 5226 may be located at a top surface of insert 5200. Permeable or porous partition 5226 may be adapted to be kept sealed by, for example, induction seal, e.g., induction seal 4210. Induction seal 4210 may be placed on in-use chamber 5720 after filling in-use chamber 5720 with the required substances and possibly after filling bottle 2800 with tablets (or with any other items as required). Thus, in-use chamber 5720 may be kept sealed, and the substance inside in-use chamber 5720 may be kept fresh and active as long as induction seal 4210 is not removed.

After induction seal 4210 is removed, permeable or porous partition 5226 may face the interior of bottle 2800, to allow humidity, oxygen and other gases pass through from the interior of bottle 2800 to in-use chamber 5720. Thus, in-use chamber 5720 may be adapted for storing substances that may be usable or active when bottle 2800 is opened for use, e.g., when induction seal 5210 is removed.

According to some embodiments, a single induction seal, e.g., induction seal 4210, may be used to seal both in-use chamber 5720 and bottle 2800. According to some embodiments, a first induction seal, e.g., induction seal 4210, may be used to seal in-use chamber 5720 and a second induction seal, e.g., induction seal 1300, may be used to seal bottle 2800. In some embodiments, insert 5200 may include a funnel to guide tablets towards the opening of bottle 2800. In some embodiments, insert 5200 may be configured to allow controlled dispensing of tablets. Other modules may be attached or loaded onto insert 5200, e.g., an RFID/NFC tag.

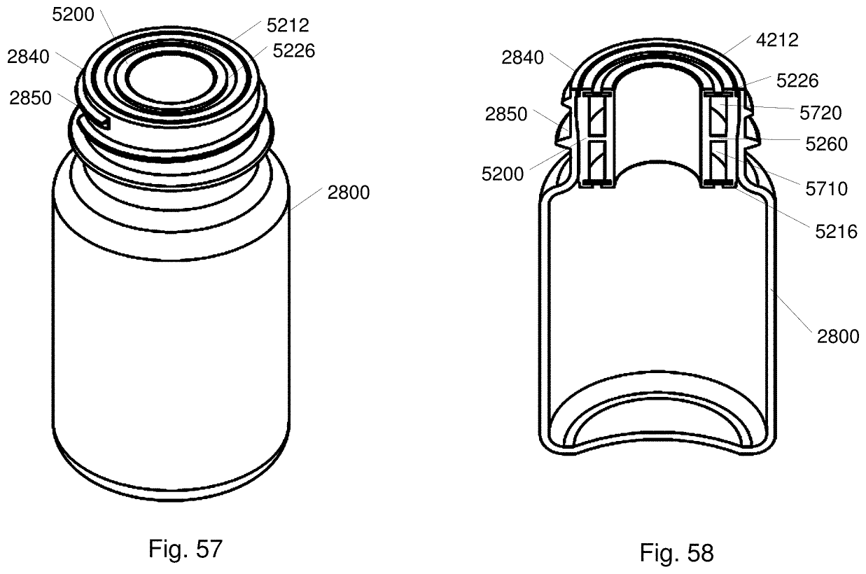

Reference is now made to FIG. 57 which is a schematic isometric view illustration of two stage example of a bottle insert 5200 assembled inside bottle 2800, and to FIG. 58 which is a schematic cross-sectional isometric view of two stage example of a bottle insert 5200 assembled inside bottle 2800, according to embodiments of the present invention. In the embodiment presented in FIGS. 57-58, top surface or rim 5212 of insert 5200 is aligned with rim or top surface 2840 of bottle 2800. Thus, a single induction seal, e.g., induction seal 1300 may be used to seal both in-use chamber 5720 and bottle 2800.

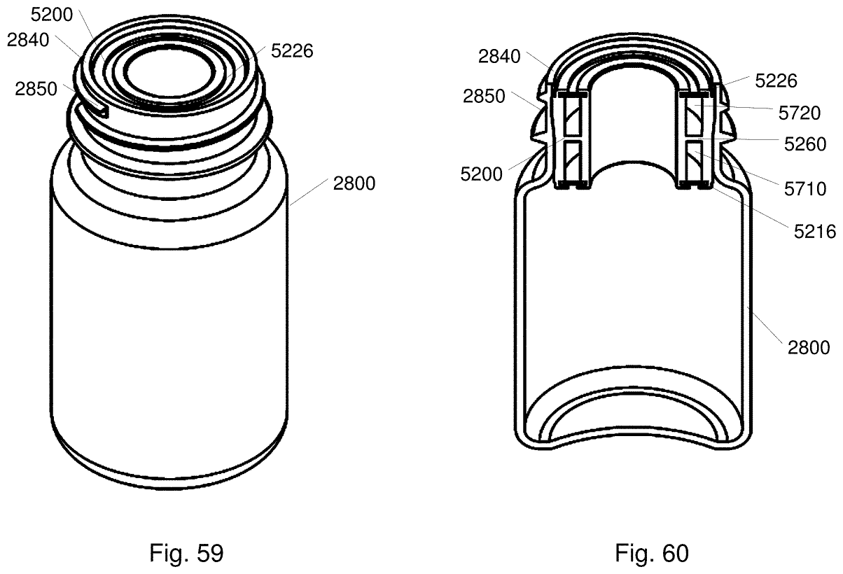

Reference is now made to FIG. 59 which is a schematic isometric view illustration of two stage example of a bottle insert 5200 assembled inside bottle 2800, and to FIG. 60 which is a schematic cross-sectional isometric view of two stage example of a bottle insert 5200 assembled inside bottle 2800, according to embodiments of the present invention. In the embodiment presented in FIGS. 59-60, top surface or rim 5212 of insert 5200 is below or slightly below rim or top surface 2840 of bottle 2800. Thus, according to this embodiment, two induction seals may be used, a first induction seal, e.g., induction seal 4210, may be used to seal in-use chamber 5720 and a second induction seal, e.g., induction seal 1300 may be used to seal bottle 2800. Both assembly options, e.g., the single induction seal option presented in FIGS. 57-58, and the double induction seal option presented in FIGS. 59-50 are suitable for insert 4200 as well.

The terms “desiccant”, “hygroscopic”, “gaseous scavenger” are used in an interchangeable manner. Any reference to a desiccant should be applied mutatis mutandis to a hygroscopic material and/or should be applied mutatis mutandis to a gaseous scavenger or any material or element that is capable of absorbing any gas and/or humidity.

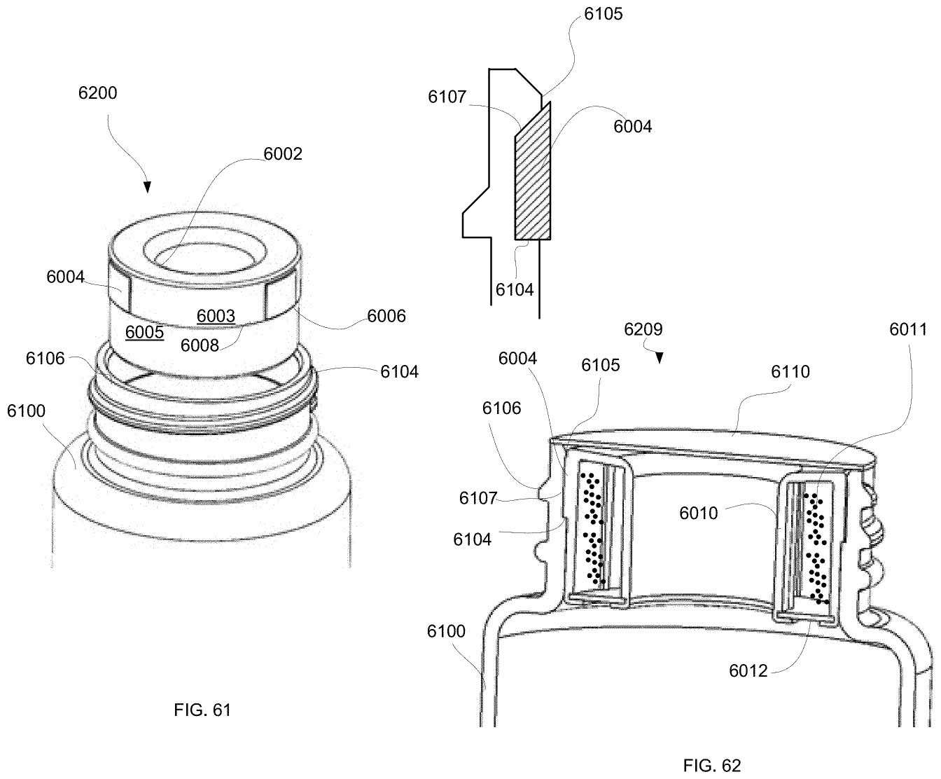

FIG. 61 is a schematic isometric view illustration of bottle insert 6200 and bottle 6100.

The bottle insert has a body 6002 and protuberances such as snap nodes 6004 and 6006 that protrude from the body 6002.

There may be any number of protuberances—one, two, three and more. The protuberances may be evenly spaced from each other and/or unevenly spaced from each other.

The protuberances may entirely surround the body 6002 (for example—form a ring)—but may only partially surround body 6002 (as illustrated in FIG. 61). The shapes and/or size of the protuberances may differ from the shapes and sizes illustrated in FIG. 61.

For example—the protuberances may have a rectangular shape, a circular shape, an elliptical shape, and the like.

Yet for another example—while FIG. 61 illustrates a protuberance that has a rounded exterior that is parallel to the upper part 6003 of the body 6002—the protuberances may have exteriors that are not parallel to the body.

For example—the protuberances may have an exterior that is inclined—for example have a top that is more distant from body than the bottom—or vice-verse.

An upper part 6003 of the body may be wider than the lower part 6005 of the body—forming a step or a stopper 6008 that may assist in preventing the bottle insert from downward slipping.

The interior of neck 6106 of bottle 6100 has a step or stopper 6104 that may contact step or a stopper 6008 of the bottle insert 6200 thereby assisting in preventing the bottle insert from downward slipping.

The interior of neck 6106 also includes an upper protuberance 6105 or an upper narrower portion in which the interior of the neck is narrower than another part of the neck—so that when the insert bottle is inserted into the bottle the one or more protuberance (6004) of the bottle insert is caught between the step or stopper 6104 and upper protuberance so that the bottle insert does slip from the bottle—either into the bottle or outside the bottle. A recess 6107 may be formed between 6104 and upper protuberance 6105. The recess may be deformable, may be created before the insertion of the bottle insert or due to the insertion of the bottle insert.

Any other upper and lower limiting features of the bottle may trap or otherwise position the bottle insert at a predefined position in relation to the bottle.

The bottle may be temporarily or non-temporarily deformed when the bottle insert is forced into its position.

Bottle insert 6200 may or may not include at least one chamber for storing one or more substances. Thus, the substance may be placed inside bottle 6100, but may be held by bottle insert 6200 and kept separated from the tablets.

FIG. 62 is a schematic cross-sectional isometric view of an example of a bottle insert 6209 assembled inside a bottle 6100, according to embodiments of the present invention.

The bottle insert 6209 includes a chamber 6010 and protuberance 6004.

Chamber 6010 has a porous or apertured bottom. The porous or appretured bottom may be partially sealed by permeable or porous partition 6012 that adapted to be located between the interior of the bottle and the chamber to allow humidity, oxygen and other gases pass through.

FIG. 62 also illustrates a substrate such as a desiccant 6011 that is positioned within chamber 6010. Non-limiting examples of desiccant include Silica Gel, molecular sieve, Oxygen scavengers or an active material that is configured to create a positive pressure within the chamber.

FIG. 62 also illustrates the neck 6106 of the bottle 6100, recess 6107 formed in the neck, a step or barrier 6104 and a seal such as induction seal 6100 that seals the bottle 6100. The induction seal 6110 may or may not contact the bottle insert 6209.

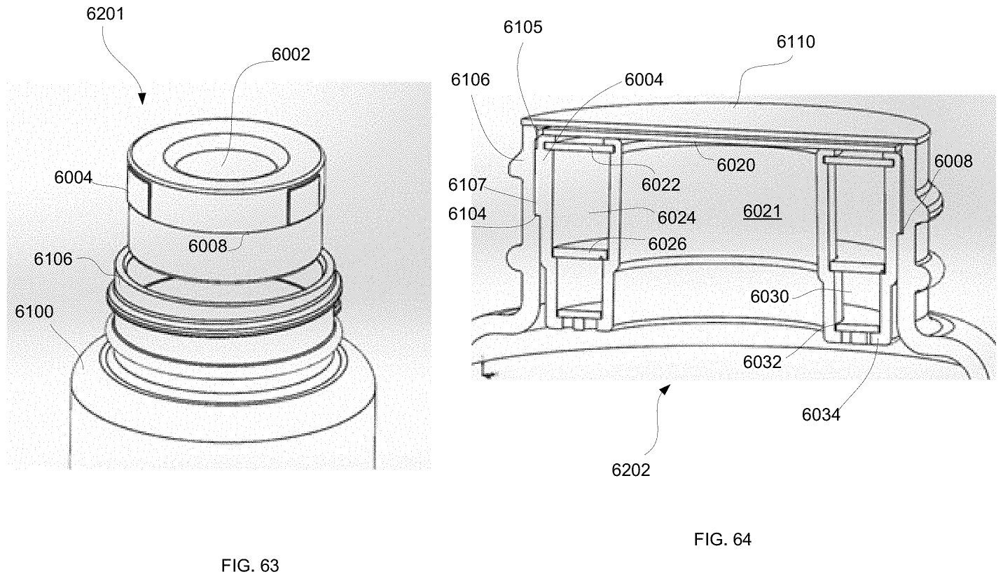

FIG. 63 is a schematic isometric view of an example of a bottle insert 6201 and a bottle, according to embodiments of the present invention.

Bottle insert 6200 can be made of a desiccant and at least one additional material.

The at least one additional material may be a filling material or/or a shape-forming material such as but not limited to a polymer or any other material that may be shaped to form the bottle insert.

The desiccant and the at least one additional material may be mixed to form bottle insert 6201.

The mixture of the desiccant and the at least one additional material may be injected and/or compressed to form the bottle insert 6201.

The bottle insert 6201 may be homogenous or non-homogenous.

The bottle insert 6201 may or may not include a chamber.

The bottle insert 6201 may include an exterior part that includes the mixture of the desiccant and the at least one additional material and an interior part that may or may not include the desiccant.

The manufacturing process of a bottle insert that is made of a mixture of the desiccant and the at least one additional material—especially a bottle insert that does not require filling an internal chamber with a substance—is much faster and less costly than the manufacturing process of a bottle insert that has one or more internal chambers that should be filled with a desiccant and then partially sealed with a porous partition.

FIG. 63 illustrates the bottle insert 6201 as including step or stopper 6008 and protuberances such as snap nodes 6004 and 6006 that protrude from the body 6002.

These protuberances and the step or stopper are optional.

Bottle insert 6201 may have any shape and/or size as long as it can be positioned within a predefined location with the bottle in which the bottle insert is inserted. inserted in.

For example—bottle insert 6201 may have any shape and/or size that fits an interior of a predefined part of the bottle (such as but not limited to neck or other part).

Bottle insert 6201 may directly or indirectly (via one or more interfacing elements) contact an inner part of the bottle—when inserted into the bottle.

FIG. 64 is a schematic cross-sectional isometric view of an example of a bottle insert 6202 assembled inside a bottle, according to embodiments of the present invention.

Bottle insert 6202 contacts neck 6106 of the bottle. Neck 6106 includes recess 6107 in which a protuberances of the bottle insert may be inserted, and protuberances 6105.

Bottle insert 6202 includes:

a. Step or a stopper 6008.
b. Protuberances 6004 such as snap nodes. The protuberances 6004
c. A first chamber such as shelf-life chamber 6030.
d. A second chamber such as in-use chamber 6024.
e. A partition 6026 that separates the in-use chamber 6024 from the shelf-life chamber 6030.
f. Permeable or porous partition 6032.
g. Permeable or porous partition 6022.
h. Bottle insert sealing element 6020.

It should be readily understood that each of shelf-life chamber 6030 and in-use chamber 6024 may be further partitioned to a plurality of chambers.

Partition 6026 may be horizontal or may be oriented in other orientation (including but not limited to a vertical orientation).

Shelf-life chamber 6030 may have a porous or apertured bottom 6034. The porous or appretured bottom 6034 may be partially sealed by permeable or porous partition 6032 that adapted to be located between the interior of the bottle and the interior of the shelf-life chamber.

Permeable or porous partition 6032 allows humidity, oxygen and other gases pass through from the interior of bottle to shelf-life chamber 6030. Thus, shelf-life chamber 6030 may be adapted for storing substances that may be usable or active regardless of whether the bottle is sealed or not. The substances placed inside shelf-life chamber 6030 may be active throughout the entire life span of the bottle. However, it is expected that with time, the substances in shelf-life chamber 6030 may become saturated and less active.

In-use chamber 6024 may also store substances, similar or different than those stored in shelf-life chamber 6030.

Bottle insert 6202 may include or may have an impermeable exterior 6021 facing the interior of the bottle, to block or not allow humidity, oxygen and other gases pass through from the interior of the bottle to in-use chamber 6024.

However, in-use chamber 6024 may have permeable or porous partition 6022.

In some embodiments permeable or porous partition 6022 may be located at a top surface of the bottle insert.

Permeable or porous partition 6022 may be adapted to be kept sealed by, for example, bottle insert sealing element 6020 and/or the induction seal 6110.

Bottle insert sealing element 6020 may be placed on in-use chamber 6024 after filling in-use chamber 6024 with the required substances and possibly after filling the bottle with tablets (or with any other items as required) or at any time—by any party.

Thus, in-use chamber 6024 may be kept sealed, and the substance inside in-use chamber 6024 may be kept fresh and active as long as bottle insert sealing element 6020 is not removed.

After bottle insert sealing element 6020 is removed, permeable or porous partition 6022 may allow humidity, oxygen and other gases pass through from the interior of the bottle to in-use chamber 6024. Thus, in-use chamber 6024 may be adapted for storing substances that may be usable or active when the bottle is opened for use, e.g., when bottle insert sealing element 6020 is removed.

According to some embodiments, a single induction seal, e.g., induction seal 6110, may be used to seal both in-use chamber 6024 and the bottle.

According to some embodiments, a first induction seal, e.g., bottle insert sealing element 6020, may be used to seal in-use chamber 6024 and a second induction seal, e.g., induction seal 6110, may be used to seal the bottle. In some embodiments, the bottle insert may include a funnel to guide tablets towards the opening of the bottle. In some embodiments, the bottle insert may be configured to allow controlled dispensing of tablets.

Any part of any bottle insert illustrated in the specification and/or any bottle insert illustrated in the specification can be made of a desiccant and at least one additional material. The at least one additional material may be a filling material or/or a shape-forming material such as but not limited to a polymer or any other material that may be shaped to form the bottle insert.

For example—any chamber of any of the bottle inserts illustrated in the application can be made of a desiccant and one or more other materials—and especially made of mixture of a desiccant and one or more other materials.

Yet for another example—any chamber of any of the bottle inserts illustrated in the application can be replaced by a hygroscopic element that is made of a desiccant and one or more other materials—and especially made of mixture of a desiccant and one or more other materials. The hygroscopic element may be hollow or may not be hollow.

The hygroscopic element may be solid and may differ from a powder.

The hygroscopic element may be configured to change a color (or other property) of at least one of its parts—as a function of the humidity it absorbs.

The hygroscopic element can be connected to the cover of the bottle.

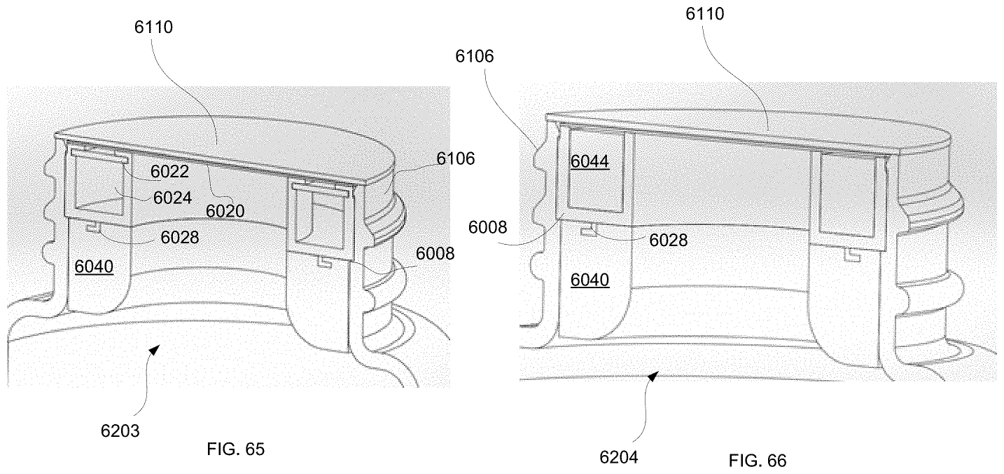

FIG. 65 is a schematic cross-sectional isometric view of an example of a bottle insert 6203 assembled inside a bottle, according to embodiments of the present invention.

The first chamber of FIG. 64 (such as a shelf-life chamber) was replaced (in FIG. 65) by a hygroscopic element that is made from a mixture of a desiccant and one or more additional materials.

Bottle insert 6203 contacts neck 6106 of the bottle.

Bottle insert 6203 includes:

a. Step or a stopper 6008.
b. Protuberances such as snap nodes (not shown).
c. A hygroscopic element 6040 that is made of a mixture of a desiccant and one or more additional materials.
d. A second chamber such as an in-use chamber 6024. The in use-chamber has a holding element 6028 that extends from the in-use chamber in order to hold hygroscopic element 6040 to the in-use chamber 6028.
e. Permeable or porous partition 6022.

The holding element 6028 can be of any shape and size and is an optional element. The holding element may include an aperture formed in chamber 6024, may be replaced by a rugged surface of chamber 6024, may be provided in combination of any part or aperture of chamber 6024.

In-use chamber 6024 can be filled with a substance such as a desiccant.

The bottle is sealed by induction seal 6110.

FIG. 66 is a schematic cross-sectional isometric view of an example of a bottle insert 6204 assembled inside a bottle, according to embodiments of the present invention.

Bottle insert 6204 contacts neck 6106 of the bottle.

Bottle insert 6000 includes:

a. Step or a stopper 6008.
b. Protuberances such as snap nodes (not shown).
c. Hygroscopic element 6040 that is made of a mixture of a desiccant and one or more additional materials.
d. A second chamber such as an in-use chamber 6024. The in use-chamber has a holding element 6028 that extends from the in-use chamber in order to hold element 6040 to the in-use chamber 6028.
e. Permeable or porous partition 6022.
f. Bottle insert sealing element 6020.

In-use chamber 6024 can be filled with a substance such as a desiccant.

The bottle is sealed by induction seal 6110.

In FIG. 66 the first chamber (such as a shelf-life chamber) was replaced by hygroscopic element 6040 that is made from a mixture of a desiccant and one or more additional materials. In addition, the second chamber (such as in-use chamber) is filled with another hygroscopic element 6044 that is made of a desiccant and/or with a mixture of a desiccant and at least one additional material. The composition of hygroscopic element 6040 may be the same as the composition of the other hygroscopic element 6044. Alternatively—the composition of the hygroscopic element 6040 may differ from the composition of the other hygroscopic element 6044.

A solid hygroscopic element 6040 does not require additional sealing elements for preventing it from being spilled (that may be required in the case of powder).

Holding element 6028, the other hygroscopic element 6044 and the hygroscopic element 6040 may be manufactured by co-injection molding. The other hygroscopic element 6044 may be injected after (before or at the same time as) the injection of the hygroscopic element 6040. Any of these elements may be manufactured by another manufacturing process.

Any chamber of any bottle insert illustrated in the specification may be further partitioned to a plurality of chambers.

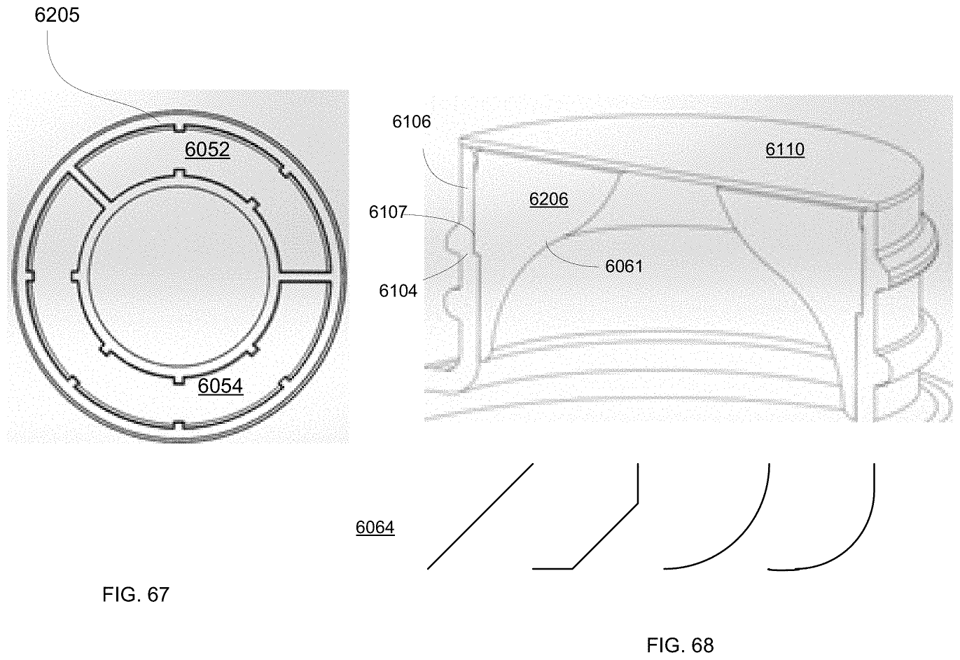

FIG. 67 illustrates a non-limiting example of a bottle insert 6025 in which a chamber such as an in-use chamber or a shelf-life chamber is partitioned to additional chambers. Each chamber out of chambers 6052 and 6054 is an arc-shaped chamber.

The number of arc-shaped chambers may exceed two.

Different arc-shaped chambers may be filled with different materials, may be filled with the same material, may be temporarily sealed with different seals, may be temporarily sealed with the same seal, may be followed or preceded by the same permeable or porous partitions, may be followed or preceded by different permeable or porous partitions, may have porous and/or non-porous bottoms, may be have porous and/or non-porous sidewalls and/or may have porous and/or non-porous tops.

For example—chamber 6052 may be filled with scavengers for absorption and chamber 6054 may be filled with a desiccant.

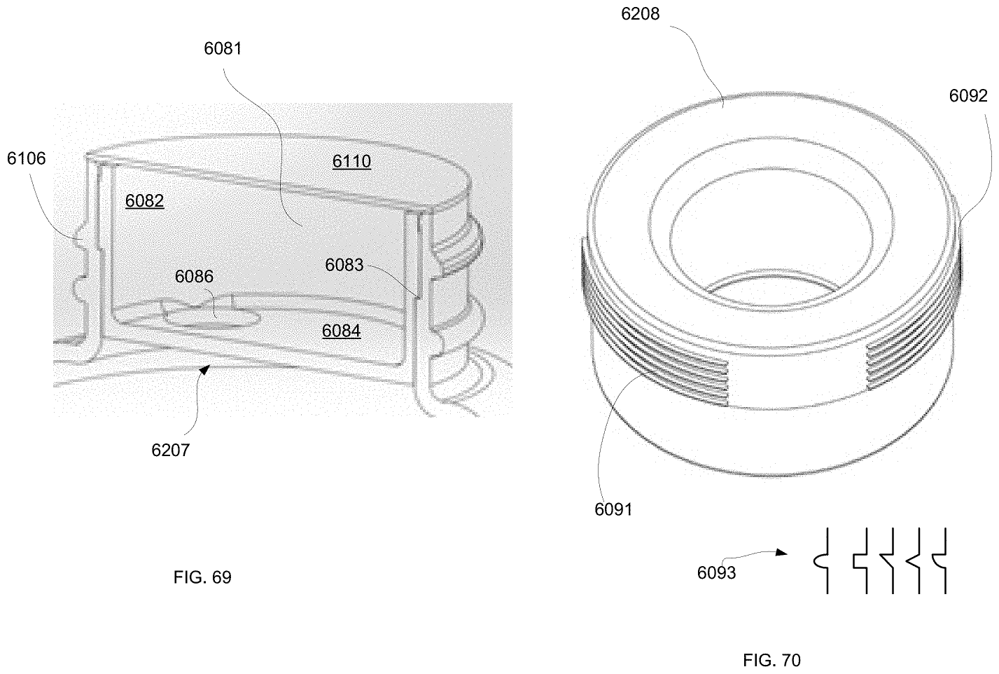

FIG. 68 is a schematic cross-sectional isometric view of an example of a bottle insert 6206 assembled inside a bottle, according to embodiments of the present invention.

Bottle insert 6206 is made of a hygroscopic material and has a curved interior 6061 that faces a symmetry axis of the bottle and reduces the inner volume of the bottle.

Bottle insert 6206 has a variable width.

The bottle insert 6206 may have other shapes and sizes—for example—linear and curved cross sections of bottle inserts are denoted 6064.

The bottle has a neck 6106 and the exterior of the bottle insert 6206 fits to the neck 6106.

The neck 6106 has a step or stopper 6104 that may contact step or a stopper (not shown) of the bottle insert thereby assisting in preventing the bottle insert from downward slipping. The bottle neck may also include an upper limiting feature that may limit upward movement of the bottle insert. The neck has a recess 6107 in which a protuberance may be inserted.

FIG. 68 also illustrates a seal such as induction seal 6110 that seals bottle 6100.

FIG. 69 is a schematic cross-sectional isometric view of an example of a bottle insert 6207 assembled inside a bottle, according to embodiments of the present invention.

Bottle insert 6207 is made of a hygroscopic material (and another material such as a polymer, a filling material and the like), has a circular bottom 6084, a radially symmetrical sidewall 6082, a step or stopper 6083 that may contact a step or a stopper (not shown) of the bottle, and an opening 6086 that is formed in the circular bottom 6084 to enable a passage therethrough of a pill (or multiple pills).

Bottle insert 6207, once inserted in the bottle, reduces the internal volume of the bottle.

FIG. 69 also illustrates a seal such as induction seal 6110 that seals the bottle.

Any of the bottle inserts may include one or more protuberances that may increase the friction between the interior of the bottle and the bottle insert. These one or more protuberances may prevent the slipping of the bottle insert within the bottle. These protuberances may have any shape and/or any size.

FIG. 70 is a schematic isometric view of an example of a bottle insert 6208, according to embodiments of the present invention.

Bottle insert 6208 has three groups of protuberances—although FIG. 70 illustrates only two groups of protuberances—group 6091′ and group 6092′.

Each one of groups 6091′ and 6092′ includes an array of six arc-shaped fins that are parallel to each other.

The number of fins may differ from six.

At least two fins of an array may be oriented to each other (non-parallel).

The fins may not be arc-shaped.

One group of protuberances may differ from another group of protuberances by size, number of fins, shape of fines, size of fins, and the like.

The fins may have any cross section—including a linear cross section, a curved cross section and/or a combination of a linear and curved cross section.

Reference number 6093 illustrates various cross sections of a fin—including a half-circle cross section, a step shaped cross section, a triangle cross section, a sawtooth cross section and a cross section that includes a linear part and curved part.

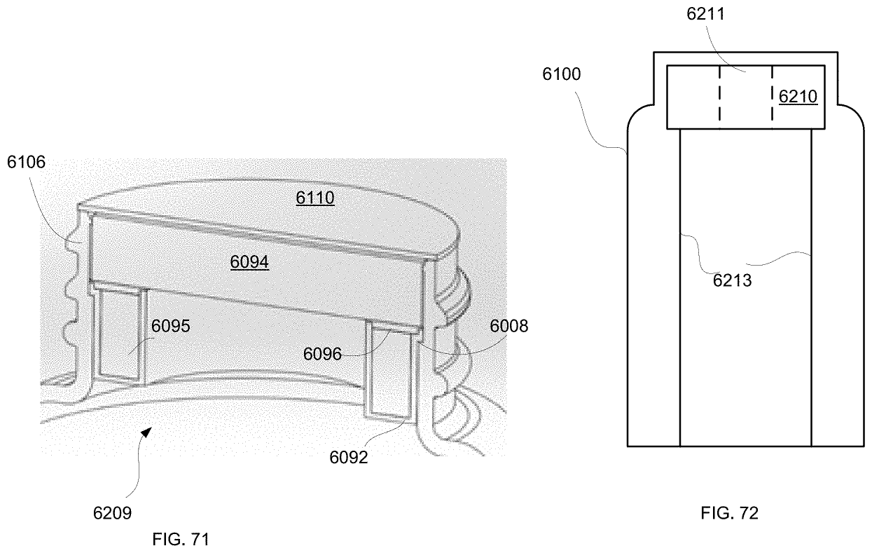

FIG. 71 is a schematic cross-sectional isometric view of an example of a bottle insert 6209 assembled inside a bottle, according to embodiments of the present invention.

Bottle insert 6209 contacts neck 6106 of the bottle.

Bottle insert 6209 may include:
a. Step or a stopper 6008.
b. Protuberances such as snap nodes.
c. A hygroscopic element 6094 that is made of a mixture of a desiccant and one or more additional materials. The hygroscopic element 6094 may be used during the shelf life period.
d. A second chamber such as an in-use chamber 6092. The in use-chamber is filled with a solid desiccant 6095.
e. In-use chamber sealing element 6096.

The bottle is sealed by induction seal 6110.

Once or after the induction seal 6110 is removed, the hygroscopic element 6094 and the in-use chamber sealing element 6096 are removed—and the solid desiccant 6095 starts to operate.

While the previous figures illustrate a bottle insert that contacted the neck of the bottle—the bottle insert may contact any part of the bottle—directly or indirectly.

FIG. 72 illustrates a bottle insert 6210 that does not contact the neck of the bottle—but is supported by one or more legs 6213 that contact the bottom of the bottle. Bottle insert 6210 defined an opening 6211 for allowing passage of pills therethrough. It should be noted that the bottle insert may contact (directly or indirectly) multiple parts of the bottle. For example—the bottle insert may contact the neck of the bottle and contact (via interfacing elements) the bottom of the bottle.

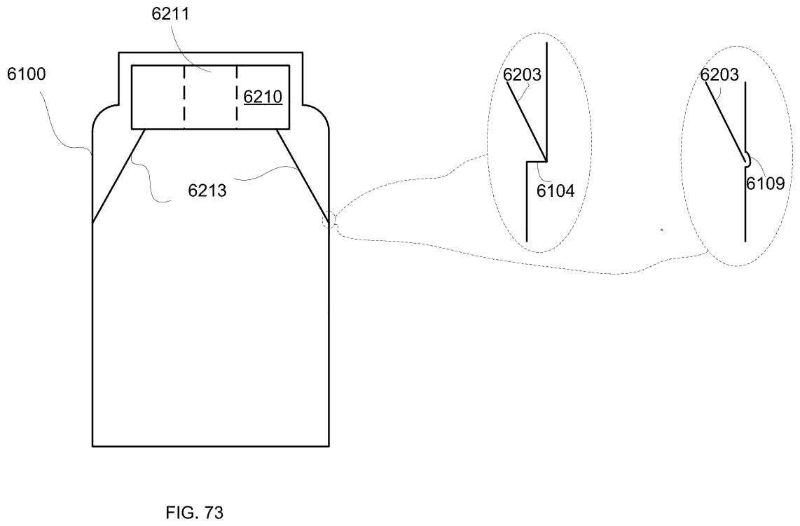

FIG. 73 illustrates a bottle insert 6210 that does not contact the neck of the bottle—but is supported by one or more legs 6213 that contact the sidewalls of the bottle—either by contacting a step 6104 (or any other protuberance) or by contacting a recess 6109 formed in the sidewall.

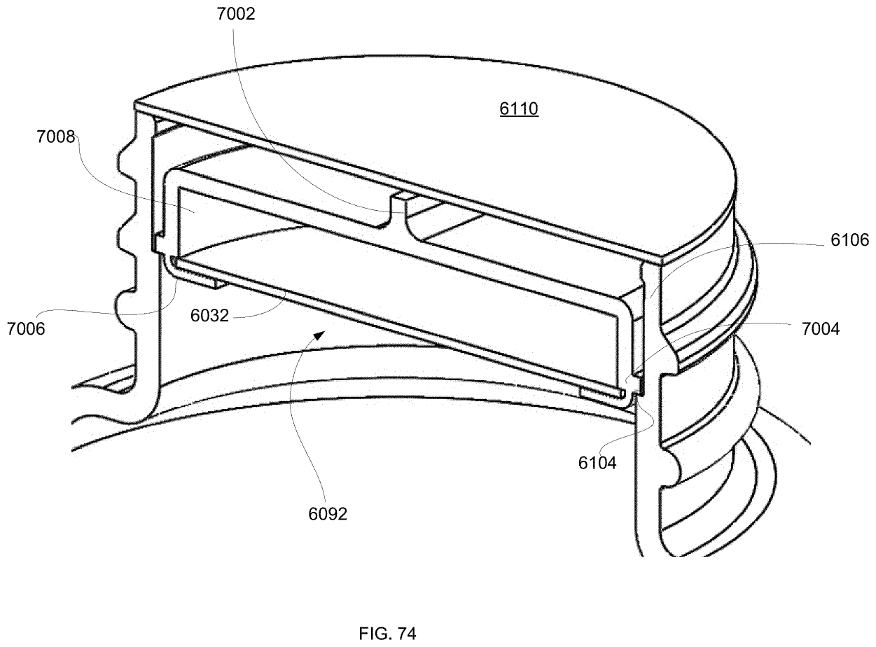

FIG. 74 is an example of cross sectional view of a bottle insert that is inserted into a bottle. The beck 6106 is sealed by seal 6100. The bottle insert includes a chamber 6902. The top of the chamber 6092 has a handle 7002. The top of the handle 7002 may contact the seal 6100 or may not contact the seal. The chamber is illustrated as a line that is positioned at the center of the top of the chamber and does not reach the periphery of the chamber. Any other handle may be used. The handle may be held by a user after the seal is removed in order to extract the bottle insert from the bottle. The lower part 7004 of the chamber extends towards the bottle insert and sit on step 6104 formed in the neck of the bottle 6106.

The chamber also includes supporting elements 7006 that support permeable partition 6032 that exposes the absorbing material 7008 to the interior of the bottle.

The chamber 6092 may be replaced by a solid absorbing element and/or may store the solid absorbing element.

The chamber 6092 may be replaced by multiple chambers.

The chamber 6092 may be shaped as a disc or may have any other shape.

The chamber 6092 is removably coupled to the neck of the bottle.

It has been found that having a bottle insert that has a different shape than the interior of the neck of the bottle may enable to insert the bottle insert into the bottle while deforming the neck of the bottle—while allowing the upper part of the neck (the part of the neck that is higher than the bottle insert) to partially shrink or otherwise propagate inwards (propagate towards its initial position—before the insertion of the bottle insert)—to assist in forming a stopper that prevents upward movements of the bottle insert. The upper part of the neck may return to its initial position or may not return to its initial position. For example—the radius of the upper part of the neck may return to its initial radius or may not return to its initial radius.

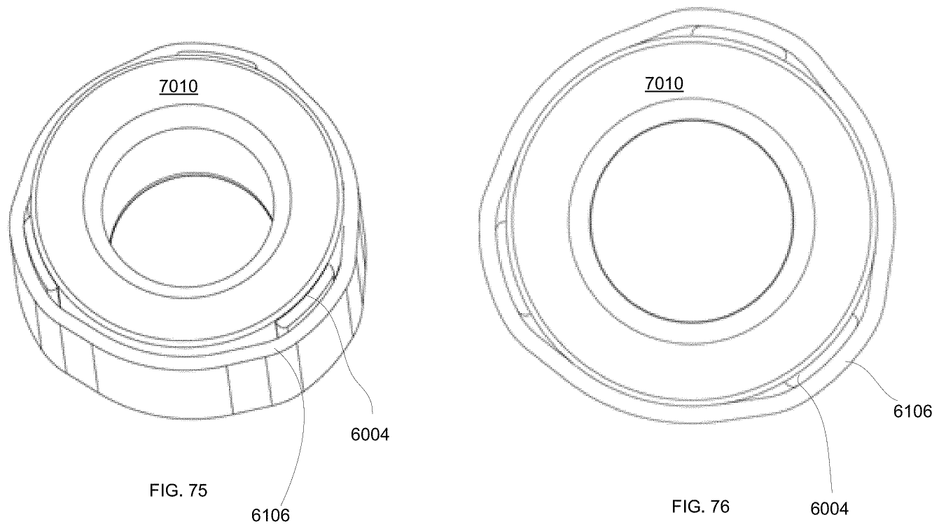

FIGS. 75 and 76 illustrates two phases of an insertion process. FIG. 75 illustrates an intermediate phase during which the bottle insert 7010 and its protuberances (for example 6044) are not fully inserted in the neck 6106 of the bottle. FIG. 76 illustrates a final phase during which the bottle insert 7010 and its protuberances (for example 6044) are fully inserted in the neck 6106 of the bottle. At the final phase the upper part of the neck 6016 moves inwards and partially covers protuberances 6044—thereby forming an upward movement stopper.

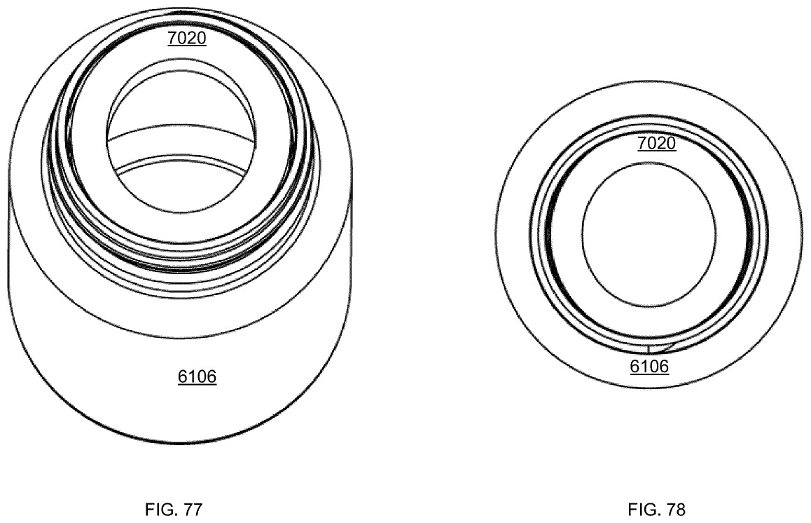

FIGS. 77 and 78 illustrates two phases of an insertion process of a body insert that has one or more protuberances having an elliptical exterior shape of cross section.

FIG. 77 illustrates an intermediate phase during which the bottle insert 7020 and its protuberances are not fully inserted in the neck 6106 of the bottle. FIG. 78 illustrates a final phase during which the bottle insert 7020 and its protuberances are fully inserted in the neck 6106 of the bottle.

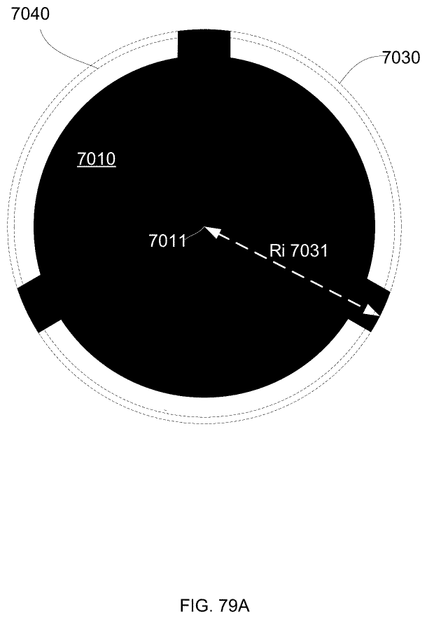

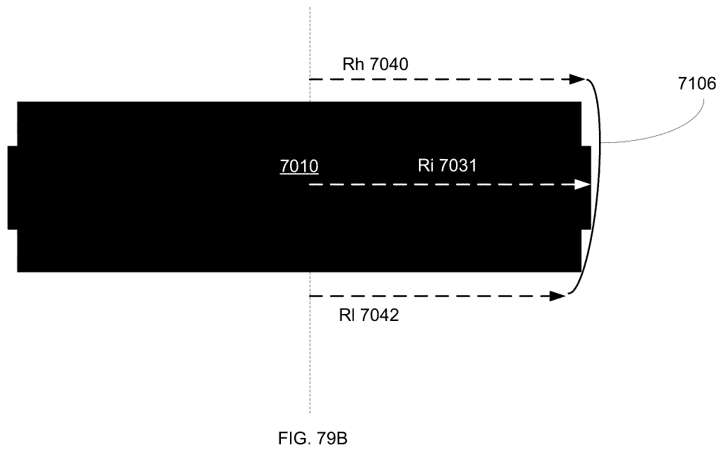

FIG. 79A is an example of a cross sectional view of a bottle insert, an imaginary circle and a radius of an upper part of a neck of a bottle after the insertion of the bottle insert.

A maximal circumference of the bottle insert 7010 (which is a horizontal circumference that includes the one or more protuberances) is smaller than a circumference of an imaginary circle 7030 having a radius (Ri 7031) that equals a maximal distance between a center of symmetry (7011) of the body and an exterior of a protuberance of the one or more protuberance.

The radius Rh 7040 of an upper part of a neck of a bottle after the insertion of the bottle insert is smaller than radius Ri 7031.

FIG. 79B is an example of a cross sectional view of a bottle insert, and a radius of an upper part and a lower part of a neck of a bottle after the insertion of the bottle insert.

Bottle insert 7010 has a radius Ri 7031 (distance between the center of symmetry of the body and a protuberance).

The radius Ri 7031 is smaller than Ri 7040 and exceeds Rl 7042 (the radius of the lower part of the neck (below the bottle insert). Rl may exceed Rh 7040.

Rl and Ri should not be taken along a step or stopper of the neck of the bottle.

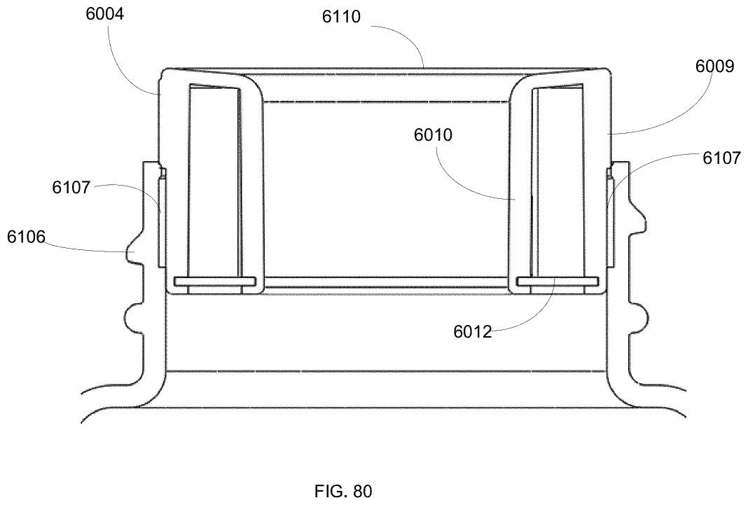

FIG. 80 is a cross section of a bottle insert that is inserted into a bottle. This figure illustrates a phase in which the bottle insert is only partially inserted into the bottle. The bottle insert includes chamber 6010, permeable or porous partition 6012, and one or more protuberances 6004. The cross section passes through protuberances (left side of the bottle insert) and through a sidewall 6009 of the chamber (right side of the bottle insert). The neck 6106 of the bottle includes recess 6107 and protuberance 6105.

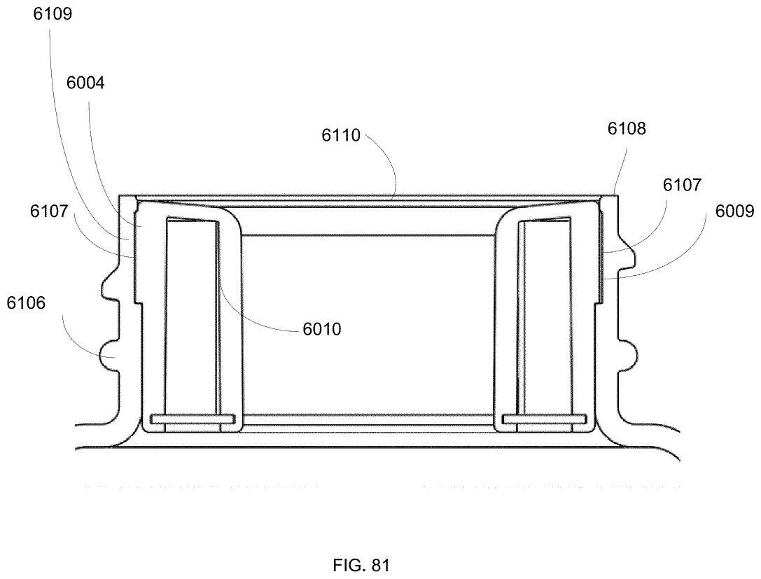

FIG. 81 is a cross section of a bottle insert that is inserted into a bottle. This figure illustrates a phase in which the bottle insert is fully inserted into the bottle. The bottle insert includes chamber 6010, permeable or porous partition 6012, and one or more protuberances 6004. The cross section passes through protuberance 6004 (left side of the bottle insert) and through a sidewall 6009 of the chamber (right side of the bottle insert). The neck 6106 of the bottle includes recess 6107 and protuberance 6105.

When fully inserted the recess 6017 surrounds the protuberance 6004 and the left upper part (6109) of the neck is slightly tilted to the left—it did not fully return to its initial position. The right upper part (6108) fully returned to its initial position (before the insertion of the bottle insert).

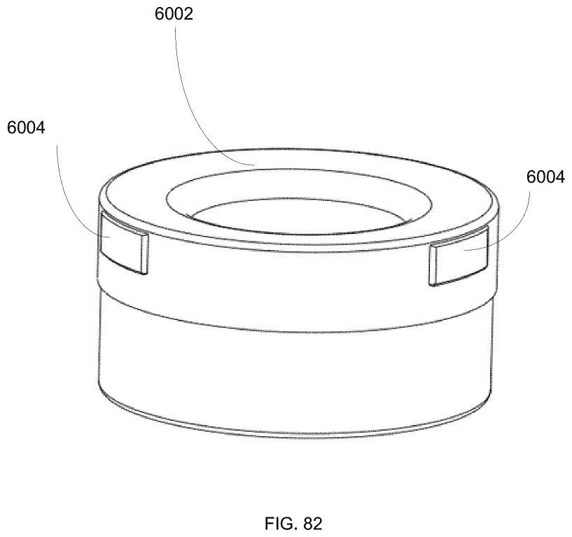

FIG. 82 illustrates a bottle insert with upper protuberances 6004 that are positioned near the top of the body 6002 and are aimed to prevent upward movements of the bottle insert (when inserted in a bottle). Lower movements may be prevented using the body itself or any other part of the body insert.

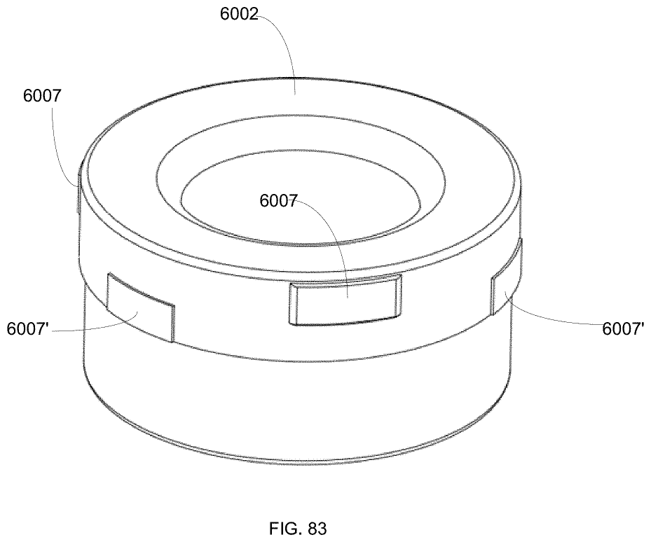

FIG. 83 illustrates a bottle insert that includes body 6002 and upper protuberances 6007 that are positioned near the top of the body 6002 and are aimed to prevent upward movements of the bottle insert (when inserted in a bottle). The bottle insert also includes lower protuberances 6007′ that are positioned below the upper protuberances 6007 and are aimed to prevent upward movements of the bottle insert (when inserted in a bottle).

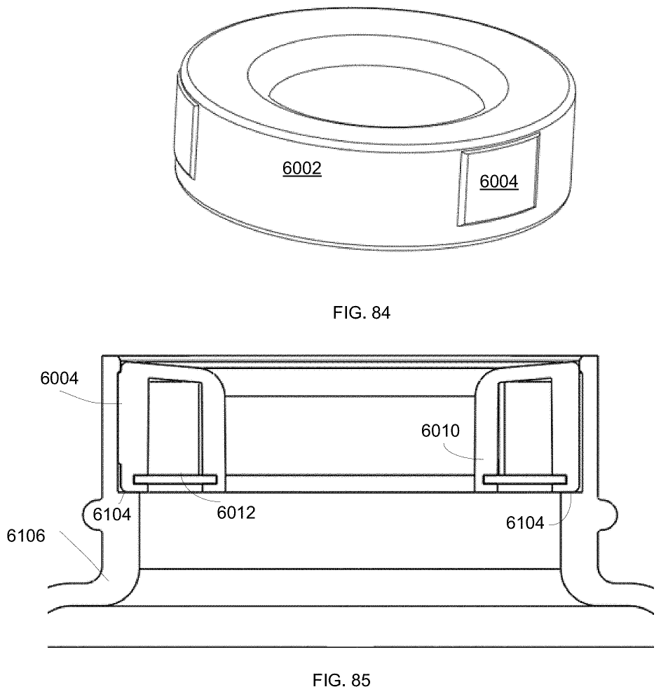

FIG. 84 illustrates a bottle insert and FIG. 85 illustrates the bottle insert while being inserted into the bottle.

The bottle insert includes body 6002, one or more protuberances 6004, chamber 6010 and permeable or porous partition 6012.

The one or more protuberances 6004 are aimed to prevent upward movements of the bottle insert (when inserted in a bottle).

The neck of the bottle includes a step or a stopper 6104 that extends inwards and supports the lower part of the bottle insert. The chamber of the bottle insert is wider that the space defined by step of stopper 6104.

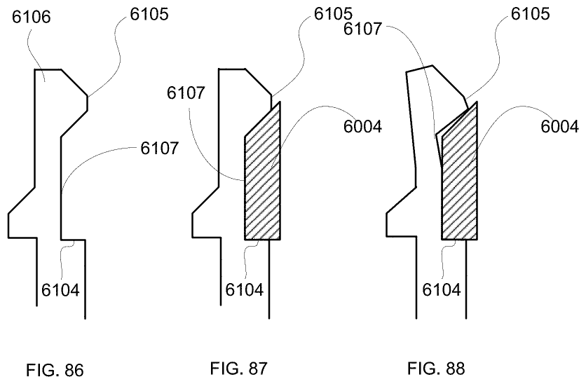

FIG. 86 is a cross section of a neck 6106 of a bottle. The neck includes step or stopper 6104, recess 6107 and protuberance 6105.

FIG. 87 is a cross section of a neck 6106 of a bottle and of a protuberance 6004 that is insert in recess 6107 wherein the upper part of the neck resumes its initial position—or at least is located at the same distance from the center of the bottle (as the initial distance).

FIG. 88 is a cross section of a neck 6106 of a bottle and of a protuberance 6004 that is insert in recess 6107 wherein the upper part of the neck does not resume its initial position—it is located at a larger distance from the center of the bottle (in comparison to the initial distance). The upper part of the neck is tilted outwards.

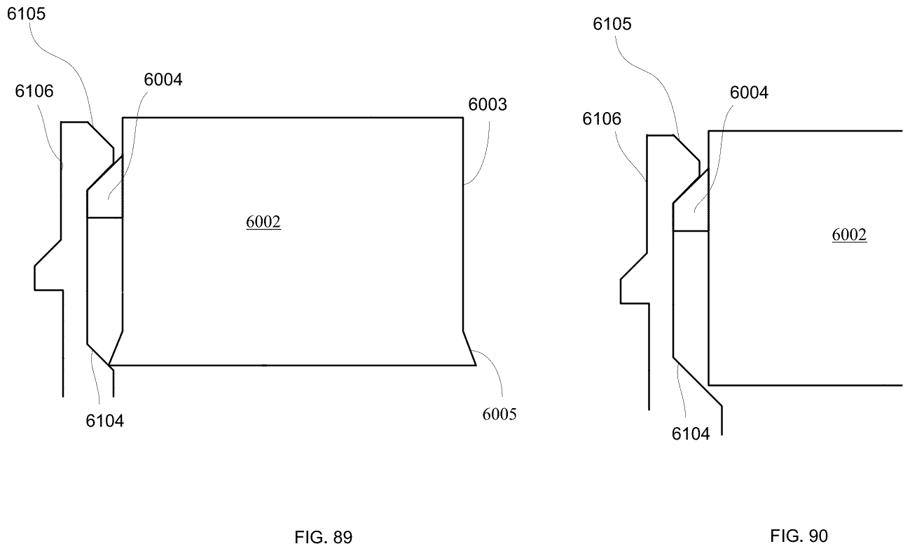

FIG. 89 illustrates a bottle insert and that is inserted into a bottle.

The bottle insert includes body 6002 and one or more protuberances 6004. The absorbing material is not shown for brevity of explanation.

The one or more protuberances 6004 are aimed to prevent upward movements of the bottle insert (when inserted in a bottle).

The neck of the bottle includes an inward inclined stopper 6104 that extends inwards and supports the lower part of the bottle insert. The lower part to the bottle insert extends outwardly and contacts stopper 6104 so that stopper 6104 prevents downward movements of the bottle insert.

FIG. 90 illustrates a bottle insert that is inserted into a bottle.

The bottle insert includes body 6002 and one or more protuberances 6004. The absorbing material is not shown for brevity of explanation.

The one or more protuberances 6004 are aimed to prevent upward movements of the bottle insert (when inserted in a bottle).

The neck of the bottle includes an inward inclined stopper 6104 that extends inwards and supports the lower part of the bottle insert. The lower part to the bottle insert does not extend outwardly—but it contacts stopper 6104 so that stopper 6104 prevents downward movements of the bottle insert.

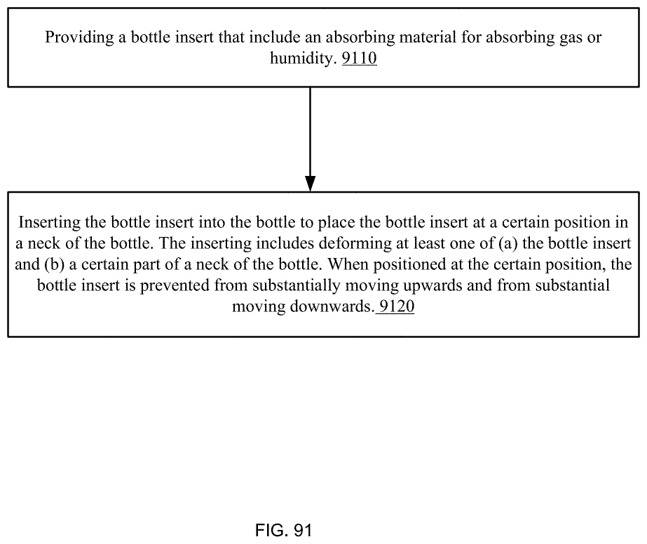

FIG. 91 illustrates method 9100. FIG. 91 may be executed by an automatic or semi-automatic insertion system.

Method 9100 may include an initial step 9110 of providing a bottle insert that include an absorbing material for absorbing gas or humidity. The absorbing material may be in the form of a powder that may be included in a chamber or may be in a non-power form—for example the absorbing power may be a solid absorbing material.

Step 9110 may be followed by step 9120 of inserting the bottle insert into the bottle to place the bottle insert at a certain position in a neck of the bottle. Step 9120 include deforming at least one of (a) the bottle insert and (b) a certain part of a neck of the bottle. When positioned at the certain position, the bottle insert is prevented from substantially moving upwards and from substantial moving downwards.

Method 9100 may involve inserting any bottle insert illustrated in any figure of the pervious figured within any bottle of any one of the previous figures and in the following figures.

The one or more protuberances may be shaped to form an external thread or a continuous or non-continuous spiral or helix.

Method 9100 may include rotating the bottle insert so that an external thread of the bottle insert will move along an internal thread of the neck of the bottle. The rotating may or may not include deforming at least one out of the neck of the bottle and the bottle insert. Alternatively, the insertion may be executed without any substantial deformation.

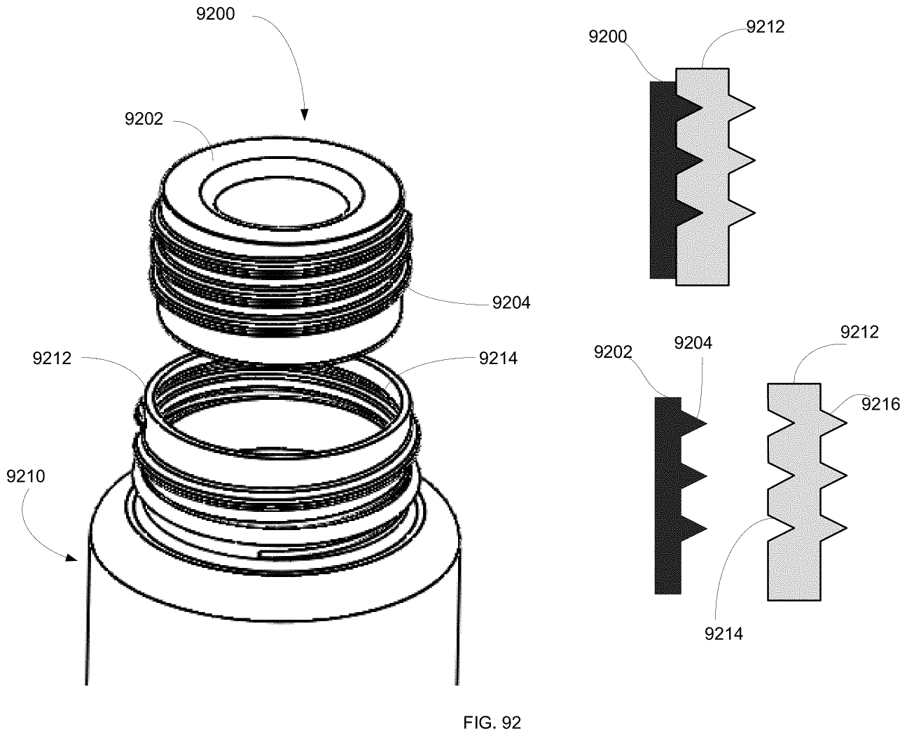

FIG. 92 illustrates a bottle 9210 and a bottle insert 9200. The bottle insert 9200 includes a body 9202 and external thread 9204. Bottle 9210 includes a neck 9212 that has internal thread 9214 and an external thread 9216.

The external thread 9204 of the bottle insert may fit the internal thread 9214 of the neck of the bottle.

Accordingly—the bottle insert may be inserted into the bottle by rotation.

The bottle insert may be rotated until reaching a desired position within the bottle.

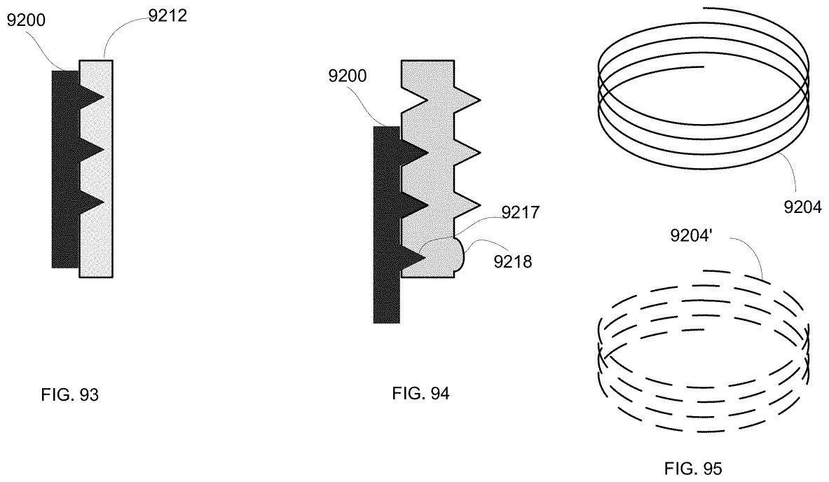

FIGS. 93 and 94 illustrate the bottle insert 9200 and the neck 9212 of the bottle.

In FIG. 93 the rotation of the bottle insert involves only rotating the bottle insert while the internal thread 9214 meshes with the external thread 9204.

In FIG. 94 the bottle insert is rotated until the external thread 9204 extends below (see region 9217) the internal thread 9214—and the bottle insert deforms (9218) the neck of the bottle. The deformation of the exterior of the neck of the bottle is optional.

FIG. 95 illustrates a continuous external thread 9204 and a non-continuous arrangement of protuberances 9204′ that are arranged along a spiral path.

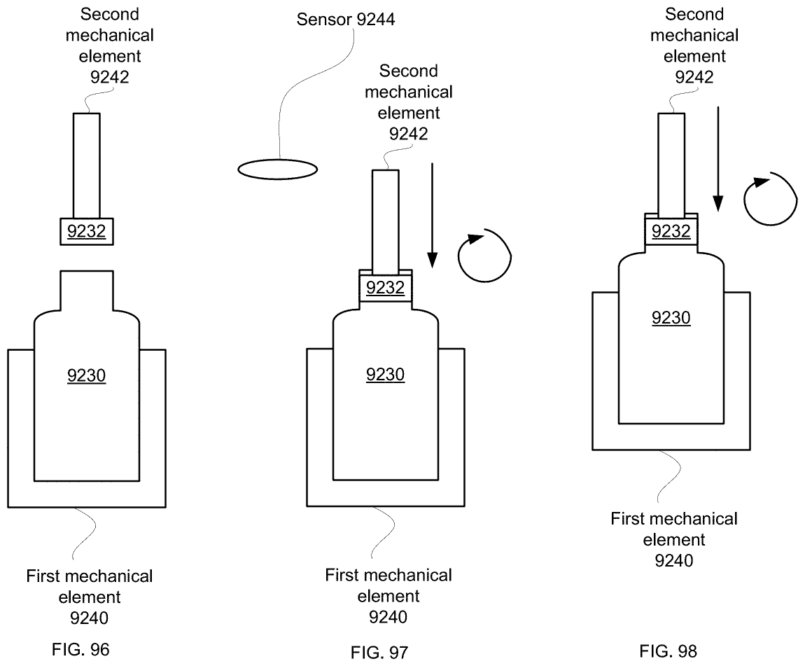

FIGS. 96, 97 and 98 illustrates various phases in the insertion of the bottle insert into the bottle.

A first mechanical element 9240 may hold or otherwise support bottle 9230. A second mechanical element 9242 may hold the bottle insert 9232. The first and/or second mechanical elements 9240 and 0242 may introduce a relative movement between the bottle and the bottle insert thereby inserting the bottle insert into the bottle to a predefined position. The movement may be linear, not-linear and may include a rotation.

The first and second mechanical elements may be an arm, a support element, a holding mechanism that may hold the bottle and/or the bottle insert while introducing relative movement. The movement may be applied using one or more motor, engine, gear, movement mechanism, and the like.

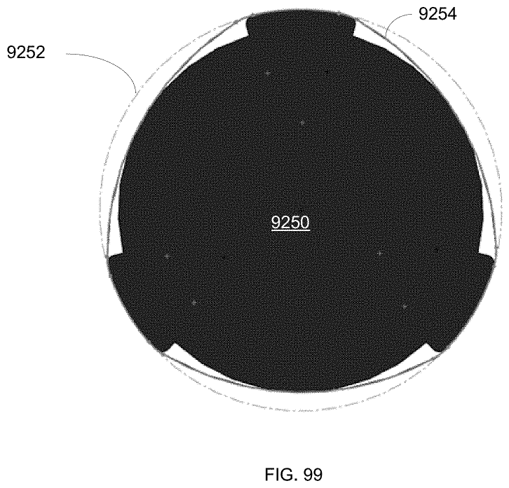

FIG. 99 is a cross sectional view of a bottle insert 9250 that is inserted within bottle, the bottle neck 9254 that is deformed due to the insertion of the bottle insert and an imaginary circle 9252.

The imaginary circle delimits three outmost parts of the three protuberances (outmost parts—points that are at the biggest distance from the center of symmetry of the body of the bottle insert).

The circumference of the bottle neck is smaller than the imaginary circle.

The ratio between the circumference of the imaginary circle and the first shape may range between 1.02 and 1.15.

It should be noted that the imaginary circle may encircle any three parts of the bottle insert—even when the number of protuberances is one, two or more than three.

Imaginary circle 9252 is defined around the three most outside features of the bottle insert—thereby providing a largest circle that encircles any features of the bottle insert.

Closed curve is a curve composed of any lines such as straight lines and/or tangent curves that enclose the bottle insert. The closed curve may be 9254.

The circumference of Imaginary circle exceeds the circumference of the closed curve.

The ratio between the circumference of the closed curve and the circumference of the Imaginary Circle (mentioned above) may, for example, range of 100:102 and 100:115)

Embodiments of the present invention are not limited to the specific examples presented herein. Features of specific examples may be added to other examples as required. For example, bottle inserts 100, 9232, 9200 and 700 may also include a two stage chamber system as disclosed herein, and insets 2200, 2900, 3600, 4200, 9200 and 9232 and 5200 may be designed to include a slide for controlled release of tables as slides 130 or 730.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Any reference to any of the terms “comprise”, “comprises”, “comprising” “including”, “may include” and “includes” may be applied to any of the terms “consists”, “consisting”, “consisting essentially of”.

Any reference to the phrase “may be” should also be interpreted as “may not be”.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “rear” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between various components are merely illustrative and that alternative embodiments may merge various components or impose an alternate decomposition of functionality upon various components. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” Each other such that the desired functionality is achieved, irrespective of architectures or intermedial components. Likewise, any two components so associated can also be viewed as being “operably connected,” or “operably coupled,” to Each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

We claim:

1. A bottle insert, comprising: a neck adapted to fit against the inside of a neck of the bottle; a first chamber adapted for storing a first substance; a second chamber adapted for storing a second substance; and a permeable partition adapted to be located between an interior of the bottle and at least one of the first chamber and the second chamber.

2. The bottle insert of claim 1, wherein the permeable partition is located at a top surface of the insert.

3. The bottle insert according to claim 2 wherein the permeable partition is adapted to be sealed by an induction seal while the bottle is closed.

4. The bottle insert of claim 1, wherein the permeable partition is located at a bottom surface of the insert.

5. The bottle insert of claim 1, wherein the first substance differs from the second substance.

6. The bottle insert of claim 1, wherein the first substance equals the second substance.

7. The bottle insert according to claim 1 wherein at least one of the first material and the second material is an absorbing material.

8. The bottle insert of claim 7, wherein the absorbing material is selectable from desiccants and oxygen scavengers.

9. The bottle insert of claim 1 wherein the insert further comprises a funnel to guide tablets towards the opening of the bottle.

10. The bottle insert according to claim 1, wherein a rim of the neck of the insert is below or substantially aligned with a rim of the neck of the bottle, to provide a sealing surface for an induction seal.

11. The bottle insert of claim 1, further comprising an induction seal adapted to seal the second chamber.

12. The bottle insert according to claim 1 wherein at least one of the first substance and the second substance is a powder.

13. The bottle insert according to claim 1 wherein at least one of the first substance and the second substance is a solid bulk that differs from powder.

14. The bottle insert of claim 1, further comprising one or more skid reduction elements.

15. The bottle insert according to claim 14, wherein at least one of the body and the one or more skid prevention elements is adapted to fit against an interior of a neck of the bottle.

16. The bottle insert according to claim 14, wherein the one or more skid prevention elements are adapted to fit within one or more recesses formed in an interior of a neck of the bottle.

17. The bottle insert according to claim 1, comprising an additional partition for partitioning between the first chamber and the second chamber.

18. The bottle insert according to claim 1, wherein the second chamber is positioned at a different height than the first chamber.

19. The bottle insert according to claim 1, wherein the second chamber is positioned at a same height as the first chamber.

20. A kit comprising a bottle insert and a bottle; wherein the bottle has a neck; wherein the bottle insert comprises a neck adapted to fit against an inside of the neck of the bottle; a first chamber adapted for storing a first substance; a second chamber adapted for storing a second substance; and a permeable partition adapted to be located between an interior of the bottle and at least one of the first chamber and the second chamber
